(19) United States
(12) Patent Application Publication
(10) Pub. No.: US 2025/0283017 A1
(43) Pub. Date: Sep. 11, 2025

(54) CLEANING COMPOSITIONS WITH ALKYLATED AMINO ACID SURFACTANTS HAVING ANTIMICROBIAL PROPERTIES

(71) Applicant: THE CLOROX COMPANY, Oakland, CA (US)

(72) Inventors: Walter Schenck, Pleasanton, CA (US); William King, Walnut Creek, CA (US)

(21) Appl. No.: 18/596,041

(22) Filed: Mar. 5, 2024

(51) Int. Cl. C11D 3/48; C11D 1/10

(52) U.S. Cl. CPC C11D 3/48; C11D 1/10

(57) ABSTRACT

A cleaning composition includes an alkylated amino acid, such as an N-acyl amino acid, an O-ester amino acid, a n-alkyl amino acid, an O-amid amino acid, or any combination of such amino acids. The cleaning composition further includes a surfactant, water and optionally one or more solvents, chelators, salts, builders, fragrances, dyes, preservatives, thickeners, and/or pH adjusters. The alkylated amino acid has a positive molecular charge at a pH of 7 or greater and further functions as an antimicrobial agent for the cleaning composition.

### FIELD

The present invention is directed toward compositions for cleaning, sanitizing and disinfecting surfaces.

### BACKGROUND

Antimicrobial compositions are very useful for cleaning hard surfaces in the household and/or other locations, such as kitchen and bathroom surfaces. Many such compositions include ingredients which may be harmful to the environment and to people using the compositions.

Accordingly, it would be advantageous to provide environmentally friendly and safer cleaning compositions while maintaining the antimicrobial cleaning efficacy of such compositions.

### BRIEF SUMMARY

In accordance with embodiments described herein, a cleaning composition comprises:
(a) an antimicrobial agent comprising one or more proteinogenic amino acids modified via alkylation, each proteinogenic amino acid modified via alkylation having a chemical structure with the following formula:

R₁—CH(NR_{2A}R_{2B})—C(═O)-M (Formula 1)
wherein:
   M is —OR_{3A} or —NR_{3B}R_{3C};
   R₁ is an unsubstituted side chain at the α-carbon of the proteinogenic amino acid, or a substituted side chain at the α-carbon of the proteinogenic amino acid, wherein the substituted side chain is selected from the group consisting of:
      —(C₃H₆)—NH—C(═NH)—NH—R₄,
      —(C₄H₈)—NH—R₄,
      —CH₂—C(═O)—O—R₄, and
      —(C₂H₄)—C(═O)—O—R₄;
   each of R_{2A} and R_{2B} is separately and independently selected from the group consisting of hydrogen, a C₈-C₁₆ alkyl group, a C₃ alkyl group forming a cyclic ring with the α-carbon and nitrogen atom bonded with the α-carbon, and a C₈-C₁₆ carbonyl group;
   each of R_{3A}, R_{3B} and R_{3C} is separately and independently hydrogen or a C₂-C₁₆ alkyl group;
   R₄ is a C₂-C₁₆ alkyl group or a C₈-C₁₆ carbonyl group; and at least one of the one or more proteinogenic amino acids modified via alkylation has a positive molecular charge;
(b) a surfactant comprising a nonionic surfactant or a zwitterionic surfactant; and
(c) optionally, one or more solvents, chelators, salts, builders, fragrances, dyes, preservatives, thickeners, pH adjusters, and any combinations or mixtures thereof;
wherein the cleaning composition has a pH from 3 to 12.

In another example embodiment, a cleaning composition comprises an antimicrobial agent comprising one or more alkylated amino acids selected from the group consisting of a N-acyl amino acid, an O-ester amino acid, a N-alkyl amino acid, an O-amide amino acid, and any combination thereof. The cleaning composition further comprises a surfactant in an amount from about 0.1% to about 10% by weight of the cleaning composition, where the surfactant comprises a nonionic surfactant or a zwitterionic surfactant, optionally one or more solvents, chelators, salts, builders, fragrances, dyes, preservatives, thickeners, pH adjusters, and any combinations or mixtures thereof, and water. At least one of the one or more alkylated amino acids has a positive molecular charge, and the cleaning composition has a pH from 3 to 12.

In a further example embodiment, a cleaning composition comprises an antimicrobial agent comprising one or more alkylated amino acids provided in an amount from about 0.01% to about 15% by weight of the cleaning composition, where at least one of the one or more alkylated amino acids has a positive molecular charge. The cleaning composition further comprises a surfactant in an amount from about 0.10% to about 10% by weight of the cleaning composition, where the surfactant comprises a nonionic surfactant or a zwitterionic surfactant, optionally one or more solvents, chelators, salts, builders, fragrances, dyes, preservatives, thickeners, pH adjusters, and any combinations or mixtures thereof, and water.

In additional embodiments, cleaning solutions including an antimicrobial agent comprising one or more alkylated amino acids can be formed so as to consist of or consist essentially of components that meet EPA Safer Choice criteria or standards.

The above and still further features and advantages of the present invention will become apparent upon consideration of the following detailed description of specific embodiments thereof.

### BRIEF DESCRIPTION OF THE DRAWINGS

FIG. 1 depicts synthesis routes for alkylating amino acid surfactant compounds as described herein.

### DETAILED DESCRIPTION

In the following detailed description, while aspects of the disclosure are disclosed, alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The terms “comprising,” “including,” “having,” and the like, as used herein, are synonymous and are open-ended terms that do not exclude additional, unrecited elements or method steps. The term “consisting of”, as used herein, excludes any element or method step that is not specified in a claim. The term “consisting essentially of”, as used herein, limits the scope of a claim to specific recited elements and method steps and as well as unrecited elements and unrecited steps that do not materially affect the basic and novel characteristics of the claimed invention. The terms “a” and “an” can refer to plural elements unless clearly indicated otherwise (e.g., “an excipient” can include, one, two or more excipients).

The term “effective amount”, as used herein, generally refers to amounts described within ranges as noted herein. Also, unless indicated otherwise, the term “percentage”, as used herein, refers to a weight percent based upon a particular material that is referenced. For example, an excipient, active ingredient or component that is present in an amount of 1% of a formulation or composition indicates that the excipient, active ingredient or other component is present in the formulation or composition as 1% by total weight of the formulation or composition. Such term is also referred to herein as “wt %” or “% by weight”. Similarly, the term “ppm” refers to parts per million on a weight/weight basis, such that, e.g., 100 ppm refers to 0.01% by weight (or 0.01 wt %). Further, the term “about” as used herein in relation to a described amount indicates that the amount can deviate or vary slightly beyond the described value by no more than 5% (e.g., “about 1% by weight” also includes a range of 0.95-1.05% by weight) while substantially maintaining the same efficacy of the formulation or composition.

In accordance with example embodiments, a cleaning composition comprises an effective amount of an antimicrobial agent comprising one or more alkylated amino acid surfactants. In further example embodiments, the one or more alkylated amino acid surfactants in the cleaning composition has a positive molecular charge, e.g., even when the composition has a pH of 7 or greater.

As used herein, the term “antimicrobial agent” refers to a compound (e.g., alkylated amino acid surfactant compound) that effectively kills or causes a reduction in amount (e.g., colonies) of microbes (e.g., bacteria or fungi), or at least prevents an increase in microbial growth on a surface when a cleaning composition including the antimicrobial agent is applied to a surface (e.g., via a spray or a wipe). For example, antimicrobial agents, when implemented in cleaning compositions as described herein and when applied to a surface to be cleaned, can be effective to cause at least a 3-log reduction against both gram-positive and gram-negative bacteria (e.g., Escherichia coli, Clostridioides difficile, Staphylococcus aureus, Salmonella enterica, etc.) within a period of 10 minutes or less after contacting the surface. The antimicrobial agent of the cleaning composition includes one or more alkylated amino acid surfactant compounds, where selection of a particular alkylated amino acid surfactant compound or a combination of specific alkylated amino acid surfactant compounds can be provided in a cleaning composition to achieve a desired cleaning effect depending upon a particular application. Alkylated amino acid surfactant compounds are also referred to herein as alkylated amino acid surfactants and alkylated amino acids.

The antimicrobial agent of the composition comprising one or more alkylated amino acid surfactants provide effective sanitizing and/or disinfecting of hard and soft surfaces when the cleaning composition is applied to such surfaces. The one or more alkylated amino acid surfactants can form the primary antimicrobial agent in a cleaning composition (e.g., no other antimicrobial agent is provided in the cleaning composition). Alternatively, the antimicrobial agent can comprise one or more alkylated amino acids as well as other compounds that exhibit antimicrobial activity.

In addition to the antimicrobial agent, cleaning compositions can also include one or more other environmentally friendly components as described herein (e.g., other surfactants, solvents, fragrances, dyes, etc.), where such compositions are formulated so as to comply with safety requirements established by the Environmental Protection Agency (EPA) Safer Choice criteria. The cleaning compositions can be liquid compositions that are implemented in any suitable carrier or other form (e.g., cleaning sprays or wipes) to facilitate cleaning of hard and soft surfaces.

As used herein, the term “substrate” is intended to include any material that is used to clean an article or a surface. Examples of cleaning substrates include, but are not limited to, wipes, mitts, pads, or a single sheet of material which is used to clean a surface by hand or a sheet of material which can be attached to a cleaning implement, such as a floor mop, handle, or a hand held cleaning tool, such as a toilet cleaning device. The term “substrate” is also intended to include any material that is used for personal cleansing applications. These substrates can be used for hard surface, soft surface, and personal care applications. Such substrates may typically be in the form of a wipe.

Such substrates may be formed of a structure of individual fibers which are interlaid, typically in a manner that is not identifiable (e.g., a nonwoven). The nonwoven substrates, or layers used to make up such a nonwoven substrate included in the present substrates may be formed by any suitable process. For example, they may be meltblown, spunbond, spunlaid, SMS (spunbond-meltblown-spunbond), coformed, carded webs, thermal bonded, thermoformed, spunlace, hydroentangled, hydroembossed, needled, or chemically bonded. Various processes for forming such nonwovens will be apparent to those of skill in the art, many of which are described in U.S. Pat. No. 7,696,109, incorporated herein by reference in its entirety. EP Applications EP992338, EP1687136, EP1861529, EP1303661, and US2004/0157524 are also herein incorporated by reference, each in its entirety. These references describe various nonwoven structures which are generally illustrative, and which may be modified by using biodegradable and/or compostable synthetic binder fibers rather than the synthetics typically employed in the prior art.

The terms “wipe”, “substrate” and the like may thus overlap in meaning, and while “wipe” may typically be used herein for convenience, it will be appreciated that this term may often be interchangeable with “substrate”.

The cleaning compositions as described herein may provide sanitization, disinfection, or sterilization, other cleaning, or other treatment. As used herein, the term “sanitize” shall mean the reduction of “target” contaminants in the inanimate environment to levels considered safe according to public health ordinance, or that reduces a “target” bacterial population by significant numbers where public health requirements have not been established. By way of example, an at least 99% reduction in bacterial population within a 24 hour time period is deemed “significant.” Greater levels of reduction (e.g., 99.9%, 99.99%, etc.) are possible, as are faster treatment times (e.g., within 10 minutes, within 7 minutes, within 5 minutes, within 3 minutes, within 2 minutes, or within 1 minute), when sanitizing or disinfecting.

The components of the cleaning compositions are described as follows.

### Antimicrobial Agents (Alkylated Amino Acid Surfactants)

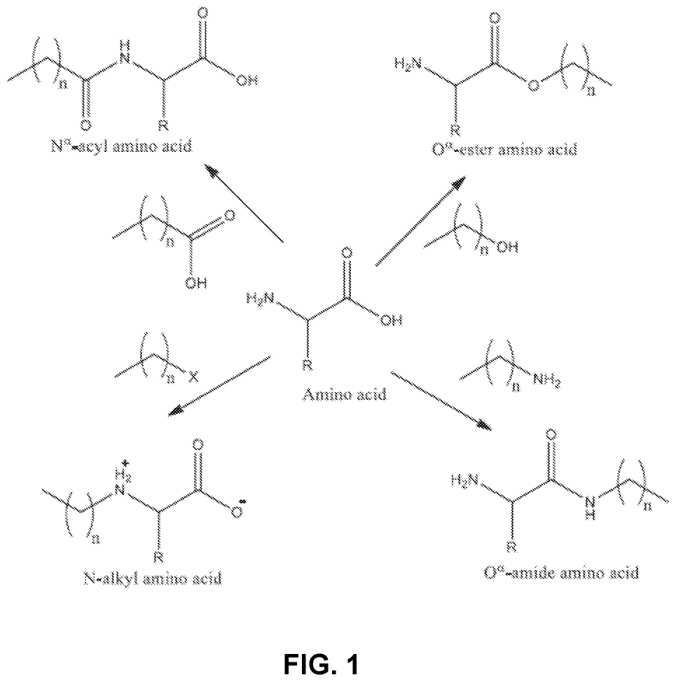

Alkylated amino acid compounds having suitable antimicrobial properties to function as antimicrobial agents for the cleaning compositions as described herein can be formed via a number of alkylation synthesis routes. Examples of known synthesis routes for alkylating an amino acid are depicted in FIG. 1.

As shown in FIG. 1, an amino acid structure having the general formula H₂N—CHR—COOH can be alkylated to form an alkylated amino acid compound including an alkyl or alkoxy chain comprising a N-alkyl group, a N-acyl group, a O-ester group, a O-amide group, and any one or more combinations thereof. In essence, the amine group (N atom) and the carboxylic acid group (O atom) of amino acids are the functional groups at which the amino acid can be alkylated, e.g., via the addition of a short or long chain alkyl or carbonyl group. The alkylation pathways depicted in FIG. 1 are for example purposes only, and it is understood that other mechanisms are also possible for alkylation of an amino acid that is useful in a cleaning composition as described herein.

Each alkylated amino acid for the cleaning compositions described herein is formed via alkylation (via one or more of the alkylation pathways such as those depicted in FIG. 1) of a proteinogenic amino acid. In particular, the antimicrobial agent of the cleaning composition can comprise any one or more of the known twenty or twenty-one proteinogenic acids modified via alkylation, where such known proteinogenic amino acids are as follows: Arginine, Histidine, Lysine, Aspartic Acid, Glutamic Acid, Serine, Threonine, Asparagine, Glutamine, Cysteine, Selenocysteine, Glycine, Proline, Alanine, Valine, Leucine, Isoleucine (structural isomer of Leucine), Methionine, Phenylalanine, Tyrosine, and Tryptophan.

As previously noted, alkylation of the amino acid, via one or more of the synthesis routes depicted in FIG. 1, occurs at an amine group (nitrogen atom) or carboxy group (an oxygen atom) along the amino acid structure, where alkylation can occur via substitution at or along any one or more of the α-carbon side chain, the amine group attached with the α-carbon, and the carboxyl group attached with the α-carbon. In particular, addition of an alkyl group to the amine group attached with the α-carbon of the amino acid can be achieved via reaction of the amino acid with CH₃—(CH₂)ₙ—CH₂—X, where n can be from 0 to 14 and X is a halide such as Cl. Addition of a carbonyl group to the amine group attached with the α-carbon of the amino acid can be achieved via reaction of the amino acid with a carboxylic acid including 2-14 carbon atoms. Addition of a C₂-C₁₆ alkyl group to the carboxyl group attached with the α-carbon of the amino acid can be achieved via reaction of the amino acid with a C₂-C₁₆ alcohol. Further, substitution of the hydroxyl group for a C₂-C₁₆ amine group at the carboxyl group attached with the α-carbon of the amino acid can be achieved via reaction of the amino acid with CH₃—(CH₂)ₙ—CH₂—NH₂, where n can be from 0 to 14. Some non-limiting examples of forming alkylated amino acids utilizing the synthesis routes as described herein are described by Pinazo et al., Amino acid-based surfactants: New antimicrobial agents, Advances in Colloid and Interface Science 228 (2016) 17-39.

Selective control of precisely where alkylation takes place can be achieved by securing one or more protecting groups at any one or more locations along the amino acid including, without limitation, a carboxylate ester protecting group. For example, in each of the reactions in which addition/substitution occurs at the carboxyl group of the amino acid, the amino acid can initially be treated with carboxylate ester protecting group such as Boc (tert-butyloxycarbonyl) which bonds with one or more amine groups of the amino acid. This protects the amine group(s) of the amino acid such that selective alkylation occurs at the carboxyl group (the desired location) of the amino acid.

The proteinogenic amino acid can be readily modified via any one of the noted alkylation synthesis routes to attached an alkyl group of any suitable size (e.g., from C₂-C₁₆ carbon atoms) at the noted N and O sites along the amino acid structure. Further, two or more alkyl groups can also be added to different N and O functional group sites via the synthesis routes described herein. For example, certain proteinogenic amino acids can be modified via di-alkylation, in which two alkyl groups of the same or different sizes can be attached at two different N or O sites along the amino acid structure.

Alkylation via these various synthesis routes results in the formation of an alkylated proteinogenic amino acid compound having suitable antimicrobial properties for cleaning compositions and comprising a chemical structure with the following formula:

R₁—CH(NR_{2A}R_{2B})—C(═O)-M (Formula 1)

where:
M is —OR_{3A} or —NR_{3B}R_{3C};
R₁ is an unsubstituted side chain at the α-carbon of the proteinogenic amino acid, or a substituted side chain at the α-carbon of the proteinogenic amino acid, wherein the substituted side chain is selected from the group consisting of:
   —(C₃H₆)—NH—C(═NH)—NH—R₄,
   —(C₄H₈)—NH—R₄,
   —CH₂—C(═O)—O—R₄, and
   —(C₂H₄)—C(═O)—O—R₄;
each of R_{2A} and R_{2B} is separately and independently selected from the group consisting of hydrogen, a C₈-C₁₆ alkyl group, a C₃ alkyl group forming a cyclic ring with the α-carbon and nitrogen atom bonded with the α-carbon, and a C₈-C₁₆ carbonyl group;
each of R_{3A}, R_{3B} and R_{3C} is separately and independently hydrogen or a C₂-C₁₆ alkyl group; and
R₄ is a C₂-C₁₆ alkyl group or a C₈-C₁₆ carbonyl group.

More specifically, alkylated amino acid compounds can be provided for cleaning compositions as described herein and comprising a chemical structure with the following formula:

R₁—CH(NR_{2A}R_{2B})—C═O)—O—R_{3A} (Formula 2)

or

R₁—CH(NR_{2A}R_{2B})—C(═O)—NR_{3B}R_{3C} (Formula 3)

where R₁, R_{2A}, R_{2B}, R_{3A}, R_{3B}, RC₃ and R₄ are the same as previously defined herein for Formula 1.

The hydrophobic alkyl chains that are added at one or more locations along the alkylated amino acid compounds generally oppose or extend from hydrophilic carboxyl or carbonyl group(s) so as to provide suitable surfactant properties for these compounds. In addition, alkylated amino acid surfactant compounds provided in cleaning compositions as described herein can be cationic, having a net positive molecular charge, particularly in a pH range of the cleaning composition from 3 to 12. For example, cationic alkylated amino acid surfactant compounds can be provided having a net molecular charge of +1 even at a pH of 7 or greater.

Example embodiments of alkylated amino acid surfactant compounds that are useful as antimicrobial agents in cleaning compositions are listed in Tables 1 and 2 herein. The examples show substitution along N and/or O sites for each of the twenty one proteinogenic amino acids. It is noted that these examples are non-limiting but are representative to show alkylation of each proteinogenic amino acid via the four different synthesis routes. In particular, while many of the examples depict a C₂, C₁₀, or a C₁₂ alkyl substitution at an N or O site of the amino acid, it is noted that substitution of one or more alkyl groups at one, two (e.g., di-alkylation) or more locations along the amino acid can also occur with a variety of different sized alkyl groups that yield structures falling within Formula 1. Further, it is noted that the preferably alkylated amino acids from Table 1 are those having a positive molecular charge at pH of 7 or greater.

TABLE 1
List of example alkylated amino acids

| | | | | Molecular |
|---|---|---|---|---|
| | | | | Charge at |
| | Proteinogenic | | | pH of 7 or |
| Example | Amino Acid | Alkylation | Substitution(s) | greater |
| 1 | Arginine | N-acyl, | R_{2A} = H (unsubstituted) | +1 |
| | | O-ester | R_{2B} = C₁₂ carbonyl | |
| | | | R_{3A} = C₂ alkyl | |
| 2 | Arginine | N-alkyl | R_{2A} = H (unsubstituted) | +1 |
| | | | R_{2B} = C₁₂ alkyl | |
| 3 | Arginine | O-ester | R_{3A} = C₁₂ alkyl | +2 |
| 4 | Arginine | O-amide | R_{3B} = H | +2 |
| | | | R_{3C} = C₁₂ alkyl | |
| 5 | Arginine | N-alkyl, | R_{2A} = H (unsubstituted) | +2 |
| | | O-ester | R_{2B} = C₁₂ alkyl | |
| | | | R_{3A} = C₂ alkyl | |
| 6 | Arginine | N-acyl, | R₁ = (C₃H₆)—NH—C(═NH)—NH—R₄ | +1 |
| | | O-ester | R_{3A} = C₂ alkyl | |
| | | | R₄ = C₁₂ carbonyl | |
| 7 | Arginine | N-alkyl | R₁ = (C₃H₆)—NH—C(═NH)—NH—R₄ | +1 |
| | | | R₄ = C₁₂ alkyl | |
| 8 | Arginine | N-alkyl, | R₁ = (C₃H₆)—NH—C(═NH)—NH—R₄ | +2 |
| | | O-ester | R_{3A} = C₂ alkyl | |
| | | | R₄ = C₁₂ alkyl | |
| 9 | Arginine | N-acyl, | R_{2A} = C₁₀ carbonyl | +1 |
| | (di-alkyl) | N-alkyl, | R_{2B} = C₁₀ alkyl | |
| | | O-ester | R_{3A} = C₂ alkyl | |
| 10 | Arginine | N-alkyl | R_{2A} = C₁₀ alkyl | +1 |
| | (di-alkyl) | | R_{2B} = C₁₀ alkyl | |
| 11 | Arginine | O-amide | R_{3B} = C₁₀ alkyl | +2 |
| | (di-alkyl) | | R_{3C} = C₁₀ alkyl | |
| 12 | Histidine | N-acyl, | R_{2A} = H (unsubstituted) | 0 |
| | | O-ester | R_{2B} = C₁₂ carbonyl | |
| | | | R_{3A} = C₂ alkyl | |
| 13 | Histidine | N-alkyl, | R_{2A} = H (unsubstituted) | +1 |
| | | O-ester | R_{2B} = C₁₂ alkyl | |
| | | | R_{3A} = C₂ alkyl | |
| 14 | Histidine | O-ester | R_{3A} = C₁₂ alkyl | +1 |
| 15 | Histidine | O-amide | R_{3B} = H | +1 |
| | | | R_{3C} = C₁₂ alkyl | |
| 16 | Lysine | N-acyl, | R_{2A} = H (unsubstituted) | +1 |
| | | O-ester | R_{2B} = C₁₂ carbonyl | |
| | | | R_{3A} = C₂ alkyl | |
| 17 | Lysine | N-alkyl | R_{2A} = H (unsubstituted) | +2 |
| | | | R_{2B} = C₁₂ alkyl | |
| 18 | Lysine | N-alkyl, | R_{2A} = H (unsubstituted) | +2 |
| | | O-ester | R_{2B} = C₁₂ alkyl | |
| | | | R_{3A} = C₂ alkyl | |
| 19 | Lysine | O-ester | R_{3A} = C₁₂ alkyl | +2 |
| 20 | Lysine | O-amide | R_{3B} = H | +2 |
| | | | R_{3C} = C₁₂ alkyl | |
| 21 | Lysine | N-acyl, | R₁ = (C₄H₈)—NH—R₄ | +1 |
| | | O-ester | R_{3A} = C₂ alkyl | |
| | | | R₄ = C₁₂ carbonyl | |
| 22 | Lysine | N-alkyl | R₁ = (C₄H₈)—NH—R₄ | +1 |
| | | | R₄ = C₁₂ alkyl | |
| 23 | Lysine | N-alkyl, | R₁ = (C₄H₈)—NH—R₄ | +2 |
| | | O-ester | R_{3A} = C₂ alkyl | |
| | | | R₄ = C₁₂ alkyl | |
| 24 | Lysine | N-acyl, | R_{2A} = C₁₀ carbonyl | +1 |
| | (di-alkyl) | N-alkyl, | R_{2B} = C₁₀ alkyl | |
| | | O-ester | R_{3A} = C₂ alkyl | |
| 25 | Lysine | N-alkyl | R_{2A} = C₁₀ alkyl | +1 |
| | (di-alkyl) | | R_{2B} = C₁₀ alkyl | |
| 26 | Lysine | O-amide | R_{3B} = C₁₀ alkyl | +2 |
| | (di-alkyl) | | R_{3C} = C₁₀ alkyl | |
| 27 | Aspartic Acid | N-acyl, | R₁ = CH₂C(═O)—O—R₄ | 0 |
| | | O-ester | R_{2A} = H (unsubstituted) | |
| | | | R_{2B} = C₁₂ carbonyl | |
| | | | R_{3A} = C₂ alkyl | |
| | | | R₄ = C₂ alkyl | |
| 28 | Aspartic Acid | N-alkyl, | R₁ = CH₂C(═O)—O—R₄ | +1 |
| | | O-ester | R_{2A} = H (unsubstituted) | |
| | | | R_{2B} = C₁₂ alkyl | |
| | | | R_{3A} = C₂ alkyl | |
| | | | R₄ = C₂ alkyl | |
| 29 | Aspartic Acid | O-ester | R₁ = CH₂C(═O)—O—R₄ | +1 |
| | | | R_{3A} = C₁₂ alkyl | |
| | | | R₄ = C₂ alkyl | |
| 30 | Aspartic Acid | O-amide, | R₁ = CH₂C(═O)—O—R₄ | +1 |
| | | O-ester | R_{3B} = H | |
| | | | R_{3C} = C₁₂ alkyl | |
| | | | R₄ = C₂ alkyl | |
| 31 | Glutamic Acid | N-acyl, | R₁ = (C₂H₄)—C(═O)—O—R₄ | 0 |
| | | O-ester | R_{2A} = H (unsubstituted) | |
| | | | R_{2B} = C₁₂ carbonyl | |
| | | | R_{3A} = C₂ alkyl | |
| | | | R₄ = C₂ alkyl | |
| 32 | Glutamic Acid | N-alkyl, | R₁ = (C₂H₄)—C(═O)—O—R₄ | +1 |
| | | O-ester | R_{2A} = H (unsubstituted) | |
| | | | R_{2B} = C₁₂ alkyl | |
| | | | R_{3A} = C₂ alkyl | |
| | | | R₄ = C₂ alkyl | |
| 33 | Glutamic Acid | O-ester | R₁ = (C₂H₄)—C(═O)—O—R₄ | +1 |
| | | | R_{3A} = C₁₂ alkyl | |
| | | | R₄ = C2 alkyl | |
| 34 | Glutamic Acid | O-amide, | R₁ = (C₂H₄)—C(═O)—O—R₄ | +1 |
| | | O-ester | R_{3B} = H | |
| | | | R_{3C} = C₁₂ alkyl | |
| | | | R₄ = C₂ alkyl | |
| 35 | Serine | N-acyl, | R_{2A} = H (unsubstituted) | 0 |
| | | O-ester | R_{2B} = C₁₂ carbonyl | |
| | | | R_{3A} = C₂ alkyl | |
| 36 | Serine | N-alkyl, | R_{2A} = H (unsubstituted) | +1 |
| | | O-ester | R_{2B} = C₁₂ alkyl | |
| | | | R_{3A} = C₂ alkyl | |
| 37 | Serine | O-ester | R_{3A} = C₁₂ alkyl | +1 |
| 38 | Serine | O-amide | R_{3B} = H | +1 |
| | | | R_{3C} = C₁₂ alkyl | |
| 39 | Threonine | N-acyl, | R_{2A} = H (unsubstituted) | 0 |
| | | O-ester | R_{2B} = C₁₂ carbonyl | |
| | | | R_{3A} = C₂ alkyl | |
| 40 | Threonine | N-alkyl, | R_{2A} = H (unsubstituted) | +1 |
| | | O-ester | R_{2B} = C₁₂ alkyl | |
| | | | R_{3A} = C₂ alkyl | |
| 41 | Threonine | O-ester | R_{3A} = C₁₂ alkyl | +1 |
| 42 | Threonine | O-amide | R_{3B} = H | +1 |
| | | | R_{3C} = C₁₂ alkyl | |
| 43 | Asparagine | N-acyl, | R_{2A} = H (unsubstituted) | 0 |
| | | O-ester | R_{2B} = C₁₂ carbonyl | |
| | | | R_{3A} = C₂ alkyl | |
| 44 | Asparagine | N-alkyl, | R_{2A} = H (unsubstituted) | +1 |
| | | O-ester | R_{2B} = C₁₂ alkyl | |
| | | | R_{3A} = C₂ alkyl | |
| 45 | Asparagine | O-ester | R_{3A} = C₁₂ alkyl | +1 |
| 46 | Asparagine | O-amide | R_{3B} = H | +1 |
| | | | R_{3C} = C₁₂ alkyl | |
| 47 | Glutamine | N-acyl, | R_{2A} = H (unsubstituted) | 0 |
| | | O-ester | R_{2B} = C₁₂ carbonyl | |
| | | | R_{3A} = C₂ alkyl | |
| 48 | Glutamine | N-alkyl, | R_{2A} = H (unsubstituted) | +1 |
| | | O-ester | R_{2B} = C₁₂ alkyl | |
| | | | R_{3A} = C₂ alkyl | |
| 49 | Glutamine | O-ester | R_{3A} = C₁₂ alkyl | +1 |
| 50 | Glutamine | O-amide | R_{3B} = H | +1 |
| | | | R_{3C} = C₁₂ alkyl | |
| 51 | Cysteine | N-acyl, | R_{2A} = H (unsubstituted) | 0 |
| | | O-ester | R_{2B} = C₁₂ carbonyl | |
| | | | R_{3A} = C₂ alkyl | |
| 52 | Cysteine | N-alkyl, | R_{2A} = H (unsubstituted) | +1 |
| | | O-ester | R_{2B} = C₁₂ alkyl | |
| | | | R_{3A} = C₂ alkyl | |
| 53 | Cysteine | O-ester | R_{3A} = C₁₂ alkyl | +1 |
| 54 | Cysteine | O-amide | R_{3B} = H | +1 |
| | | | R_{3C} = C₁₂ alkyl | |
| 55 | Selenocysteine | N-acyl, | R_{2A} = H (unsubstituted) | −1 |
| | | O-ester | R_{2B} = C₁₂ carbonyl | |
| | | | R_{3A} = C₂ alkyl | |
| 56 | Selenocysteine | N-alkyl, | R_{2A} = H (unsubstituted) | 0 |
| | | O-ester | R_{2B} = C₁₂ alkyl | |
| | | | R_{3A} = C₂ alkyl | |
| 57 | Selenocysteine | O-ester | R_{3A} = C₁₂ alkyl | 0 |
| 58 | Selenocysteine | O-amide | R_{3B} = H | 0 |
| | | | R_{3C} = C₁₂ alkyl | |
| 59 | Glycine | N-acyl, | R_{2A} = H (unsubstituted) | 0 |
| | | O-ester | R_{2B} = C₁₂ carbonyl | |
| | | | R_{3A} = C₂ alkyl | |
| 60 | Glycine | N-alkyl, | R_{2A} = H (unsubstituted) | +1 |
| | | O-ester | R_{2B} = C₁₂ alkyl | |
| | | | R_{3A} = C₂ alkyl | |
| 61 | Glycine | O-ester | R_{3A} = C₁₂ alkyl | +1 |
| 62 | Glycine | O-amide | R_{3B} = H | +1 |
| | | | R_{3C} = C₁₂ alkyl | |
| 63 | Proline | N-acyl, | R_{2A} = C₃ alkyl forming cyclic ring | 0 |
| | | O-ester | with α-C and N | |
| | | | R_{2B} = C₁₂ carbonyl | |
| | | | R_{3A} = C₂ alkyl | |
| 64 | Proline | N-alkyl, | R_{2A} = C₃ alkyl forming cyclic ring | +1 |
| | | O-ester | with α-C and N | |
| | | | R_{2B} = C₁₂ alkyl | |
| | | | R_{3A} = C₂ alkyl | |
| 65 | Proline | O-ester | R_{3A} = C₁₂ alkyl | +1 |
| 66 | Proline | O-amide | R_{3B} = H | +1 |
| | | | R_{3C} = C₁₂ alkyl | |
| 67 | Alanine | N-acyl, | R_{2A} = H (unsubstituted) | 0 |
| | | O-ester | R_{2B} = C₁₂ carbonyl | |
| | | | R_{3A} = C₂ alkyl | |
| 68 | Alanine | N-alkyl, | R_{2A} = H (unsubstituted) | +1 |
| | | O-ester | R_{2B} = C₁₂ alkyl | |
| | | | R_{3A} = C₂ alkyl | |
| 69 | Alanine | O-ester | R_{3A} = C₁₂ alkyl | +1 |
| 70 | Alanine | O-amide | R_{3B} = H | +1 |
| | | | R_{3C} = C₁₂ alkyl | |
| 71 | Valine | N-acyl, | R_{2A} = H (unsubstituted) | 0 |
| | | O-ester | R_{2B} = C₁₂ carbonyl | |
| | | | R_{3A} = C₂ alkyl | |
| 72 | Valine | N-alkyl, | R_{2A} = H (unsubstituted) | +1 |
| | | O-ester | R_{2B} = C₁₂ alkyl | |
| | | | R_{3A} = C₂ alkyl | |
| 73 | Valine | O-ester | R_{3A} = C₁₂ alkyl | +1 |
| 74 | Valine | O-amide | R_{3B} = H | +1 |
| | | | R_{3C} = C₁₂ alkyl | |
| 75 | Isoleucine | N-acyl, | R_{2A} = H (unsubstituted) | 0 |
| | | O-ester | R_{2B} = C₁₂ carbonyl | |
| | | | R_{3A} = C₂ alkyl | |
| 76 | Isoleucine | N-alkyl, | R_{2A} = H (unsubstituted) | +1 |
| | | O-ester | R_{2B} = C₁₂ alkyl | |
| | | | R_{3A} = C₂ alkyl | |
| 77 | Isoleucine | O-ester | R_{3A} = C₁₂ alkyl | +1 |
| 78 | Isoleucine | O-amide | R_{3B} = H | +1 |
| | | | R_{3C} = C₁₂ alkyl | |
| 79 | Leucine | N-acyl, | R_{2A} = H (unsubstituted) | 0 |
| | | O-ester | R_{2B} = C₁₂ carbonyl | |
| | | | R_{3A} = C₂ alkyl | |
| 80 | Leucine | N-alkyl, | R_{2A} = H (unsubstituted) | +1 |
| | | O-ester | R_{2B} = C₁₂ alkyl | |
| | | | R_{3A} = C₂ alkyl | |
| 81 | Leucine | O-ester | R_{3A} = C₁₂ alkyl | +1 |
| 82 | Leucine | O-amide | R_{3B} = H | +1 |
| | | | R_{3C} = C₁₂ alkyl | |
| 83 | Methionine | N-acyl, | R_{2A} = H (unsubstituted) | 0 |
| | | O-ester | R_{2B} = C₁₂ carbonyl | |
| | | | R_{3A} = C₂ alkyl | |
| 84 | Methionine | N-alkyl, | R_{2A} = H (unsubstituted) | +1 |
| | | O-ester | R_{2B} = C₁₂ alkyl | |
| | | | R_{3A} = C₂ alkyl | |
| 85 | Methionine | O-ester | R_{3A} = C₁₂ alkyl | +1 |
| 86 | Methionine | O-amide | R_{3B} = H | +1 |
| | | | R_{3C} = C₁₂ alkyl | |
| 87 | Phenylalanine | N-acyl, | R_{2A} = H (unsubstituted) | 0 |
| | | O-ester | R_{2B} = C₁₂ carbonyl | |
| | | | R_{3A} = C₂ alkyl | |
| 88 | Phenylalanine | N-alkyl, | R_{2A} = H (unsubstituted) | +1 |
| | | O-ester | R_{2B} = C₁₂ alkyl | |
| | | | R_{3A} = C₂ alkyl | |
| 89 | Phenylalanine | O-ester | R_{3A} = C₁₂ alkyl | +1 |
| 90 | Phenylalanine | O-amide | R_{3B} = H | +1 |
| | | | R_{3C} = C₁₂ alkyl | |
| 91 | Tyrosine | N-acyl, | R_{2A} = H (unsubstituted) | 0 |
| | | O-ester | R_{2B} = C₁₂ carbonyl | |
| | | | R_{3A} = C₂ alkyl | |
| 92 | Tyrosine | N-alkyl, | R_{2A} = H (unsubstituted) | +1 |
| | | O-ester | R_{2B} = C₁₂ alkyl | |
| | | | R_{3A} = C₂ alkyl | |
| 93 | Tyrosine | O-ester | R_{3A} = C₁₂ alkyl | +1 |
| 94 | Tyrosine | O-amide | R_{3B} = H | +1 |
| | | | R_{3C} = C₁₂ alkyl | |
| 95 | Tryptophan | N-acyl, | R_{2A} = H (unsubstituted) | 0 |
| | | O-ester | R_{2B} = C₁₂ carbonyl | |
| | | | R_{3A} = C₂ alkyl | |
| 96 | Tryptophan | N-alkyl, | R_{2A} = H (unsubstituted) | +1 |
| | | O-ester | R_{2B} = C₁₂ alkyl | |
| | | | R_{3A} = C₂ alkyl | |
| 97 | Tryptophan | O-ester | R_{3A} = C₁₂ alkyl | +1 |
| 98 | Tryptophan | O-amide | R_{3B} = H | +1 |
| | | | R_{3C} = C₁₂ alkyl | |

TABLE 2
List of structures for examples in Table 1

| Example | Chemical Structure |
|---|---|
| 1 | 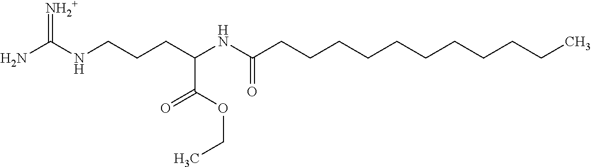 [SMILES: CCCCCCCCCCCC(=O)NC(CCCNC(N)=[NH2+])C(=O)OCC] |
| 2 | 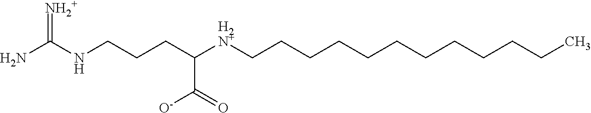 |
| 3 | 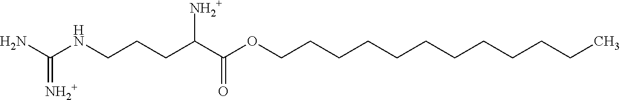 [SMILES: CCCCCCCCCCCCOC(=O)C([NH3+])CCCNC(N)=[NH2+]] |
| 4 | 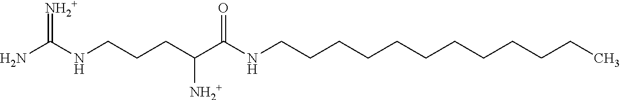 [SMILES: CCCCCCCCCCCCNC(=O)C([NH3+])CCCNC(N)=[NH2+]] |
| 5 | 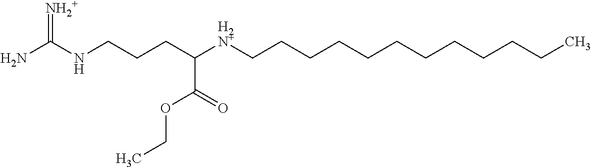 |
| 6 | 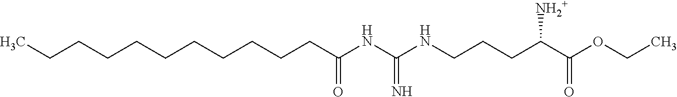 [SMILES: CCCCCCCCCCCC(=O)NC(=N)NCCC[C@H]([NH3+])C(=O)OCC] |
| 7 | 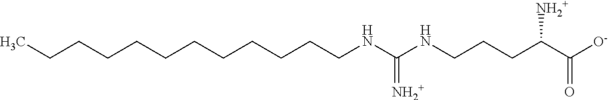 [SMILES: CCCCCCCCCCCCNC(=[NH2+])NCCC[C@H]([NH3+])C(=O)[O-]] |
| 8 | 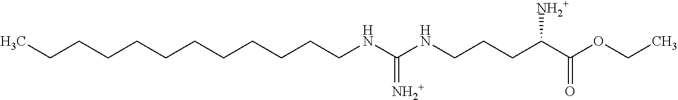 [SMILES: CCCCCCCCCCCCNC(=[NH2+])NCCC[C@H]([NH3+])C(=O)OCC] |
| 9 | 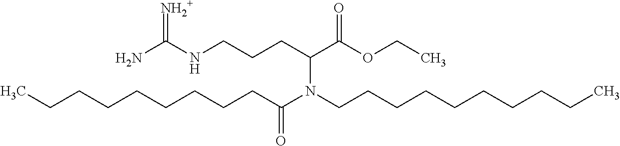 [SMILES: CCCCCCCCCCN(C(=O)CCCCCCCCC)C(CCCNC(N)=[NH2+])C(=O)OCC] |
| 10 | 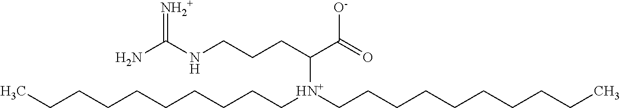 [SMILES: CCCCCCCCCC[NH+](CCCCCCCCCC)C(CCCNC(N)=[NH2+])C(=O)[O-]] |
| 11 | 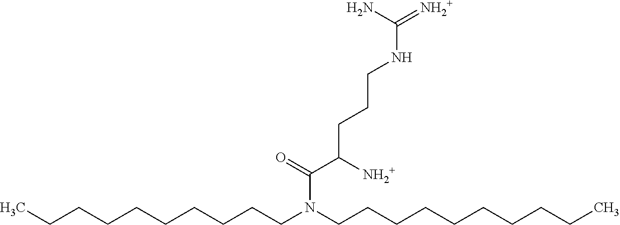 [SMILES: CCCCCCCCCCN(CCCCCCCCCC)C(=O)C([NH3+])CCCNC(N)=[NH2+]] |
| 12 | 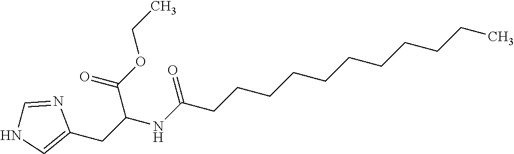 [SMILES: CCCCCCCCCCCC(=O)NC(Cc1c[nH]cn1)C(=O)OCC] |
| 13 | 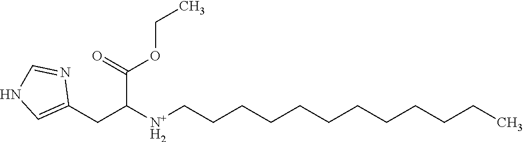 |
| 14 | 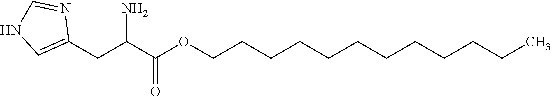 [SMILES: CCCCCCCCCCCCOC(=O)C([NH3+])Cc1c[nH]cn1] |
| 15 | 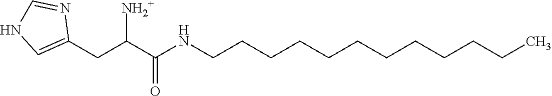 [SMILES: CCCCCCCCCCCCNC(=O)C([NH3+])Cc1c[nH]cn1] |
| 16 | 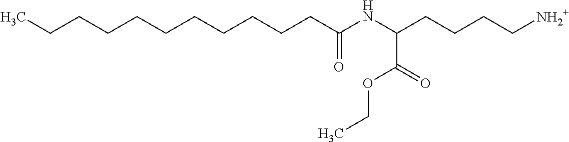 [SMILES: CCCCCCCCCCCC(=O)NC(CCCC[NH3+])C(=O)OCC] |
| 17 | 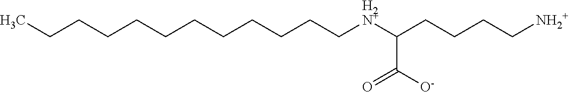 |
| 18 | 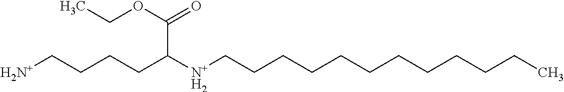 |
| 19 | 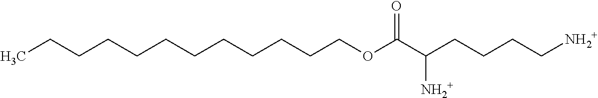 [SMILES: CCCCCCCCCCCCOC(=O)C([NH3+])CCCC[NH3+]] |
| 20 | 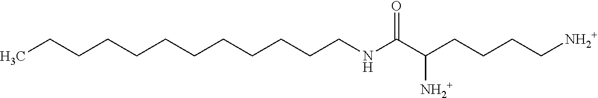 [SMILES: CCCCCCCCCCCCNC(=O)C([NH3+])CCCC[NH3+]] |
| 21 | 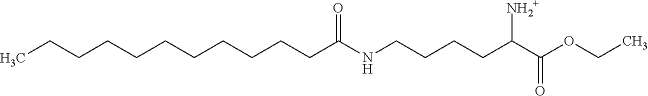 [SMILES: CCCCCCCCCCCC(=O)NCCCCC([NH3+])C(=O)OCC] |
| 22 | 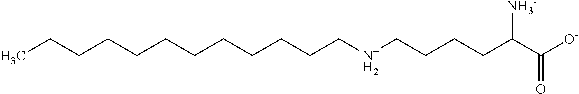 |
| 23 | 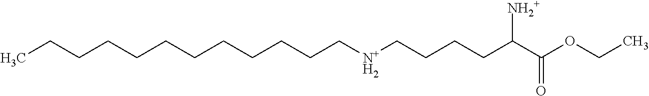 |
| 24 | 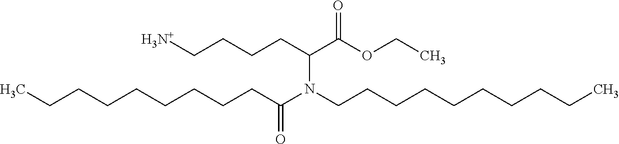 [SMILES: CCCCCCCCCCN(C(=O)CCCCCCCCC)C(CCCC[NH3+])C(=O)OCC] |
| 25 | 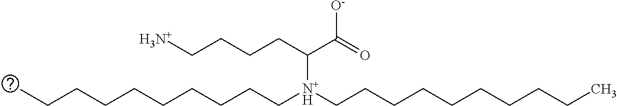 |
| 26 | 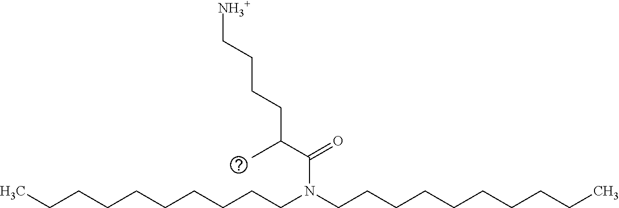 [SMILES: CCCCCCCCCCN(CCCCCCCCCC)C(=O)C(C)CCCC[NH3+]] |
| 27 | 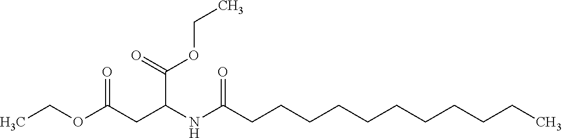 [SMILES: CCCCCCCCCCCC(=O)NC(CC(=O)OCC)C(=O)OCC] |
| 28 | 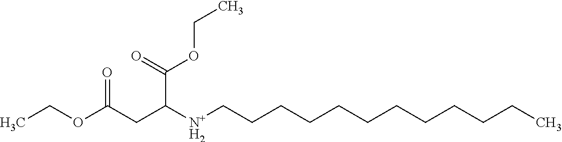 |
| 29 | 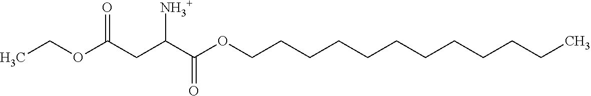 [SMILES: CCCCCCCCCCCCOC(=O)C([NH3+])CC(=O)OCC] |
| 30 | 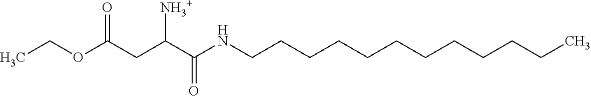 [SMILES: CCCCCCCCCCCCNC(=O)C([NH3+])CC(=O)OCC] |
| 31 | 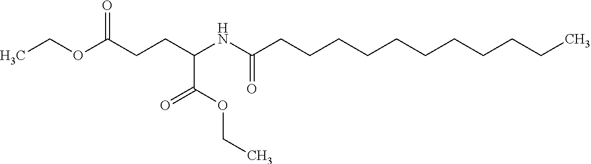 [SMILES: CCCCCCCCCCCC(=O)NC(CCC(=O)OCC)C(=O)OCC] |
| 32 | 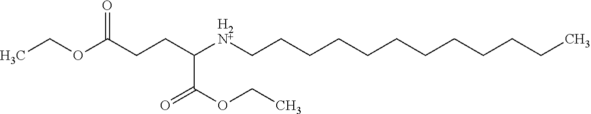 |
| 33 | 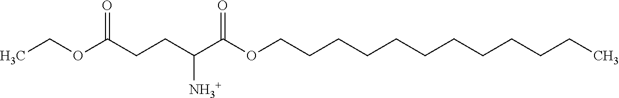 [SMILES: CCCCCCCCCCCCOC(=O)C([NH3+])CCC(=O)OCC] |
| 34 | 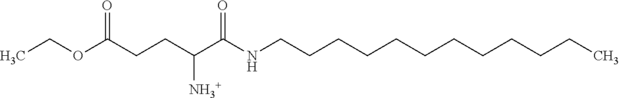 [SMILES: CCCCCCCCCCCCNC(=O)C([NH3+])CCC(=O)OCC] |
| 35 | 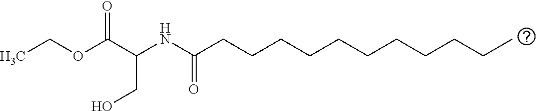 [SMILES: CCCCCCCCCCCC(=O)NC(CO)C(=O)OCC] |
| 36 | 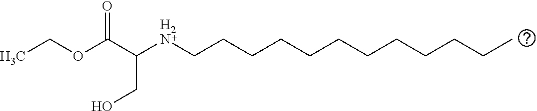 |
| 37 | 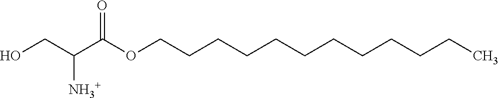 [SMILES: CCCCCCCCCCCCOC(=O)C([NH3+])CO] |
| 38 | 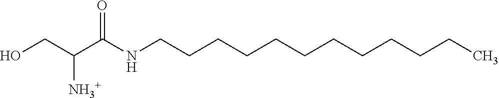 [SMILES: CCCCCCCCCCCCNC(=O)C([NH3+])CO] |
| 39 | 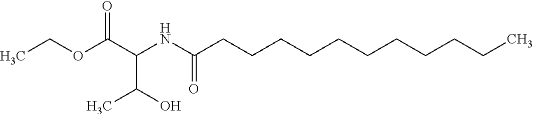 [SMILES: CCCCCCCCCCCC(=O)NC(C(=O)OCC)C(C)O] |
| 40 | 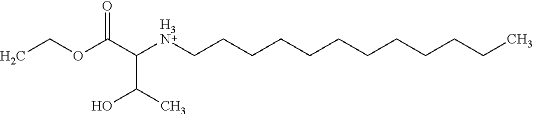 |
| 41 | 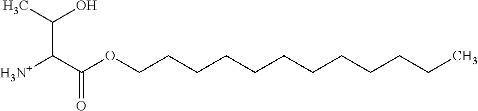 [SMILES: CCCCCCCCCCCCOC(=O)C([NH3+])C(C)O] |
| 42 | 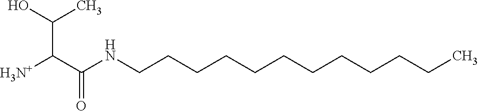 [SMILES: CCCCCCCCCCCCNC(=O)C([NH3+])C(C)O] |
| 43 | 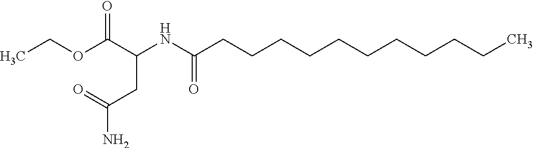 [SMILES: CCCCCCCCCCCC(=O)NC(CC(N)=O)C(=O)OCC] |
| 44 | 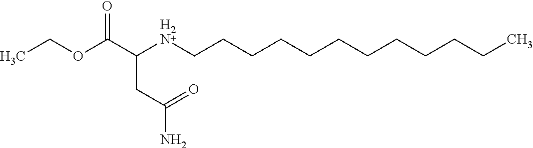 |
| 45 | 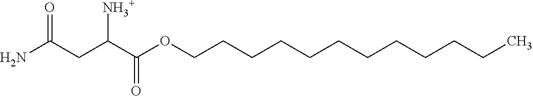 [SMILES: CCCCCCCCCCCCOC(=O)C([NH3+])CC(N)=O] |
| 46 | 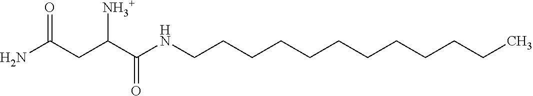 [SMILES: CCCCCCCCCCCCNC(=O)C([NH3+])CC(N)=O] |
| 47 | 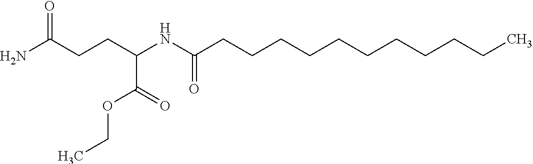 [SMILES: CCCCCCCCCCCC(=O)NC(CCC(N)=O)C(=O)OCC] |
| 48 | 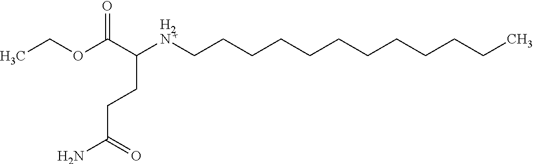 |
| 49 | 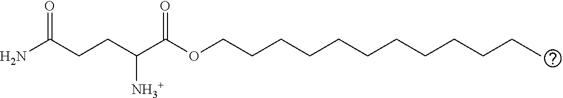 [SMILES: CCCCCCCCCCCCOC(=O)C([NH3+])CCC(N)=O] |
| 50 | 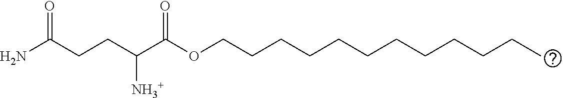 [SMILES: CCCCCCCCCCCCOC(=O)C([NH3+])CCC(N)=O] |
| 51 | 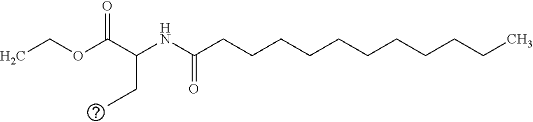 [SMILES: CCCCCCCCCCCC(=O)NC(CC)C(=O)OCC] |
| 52 | 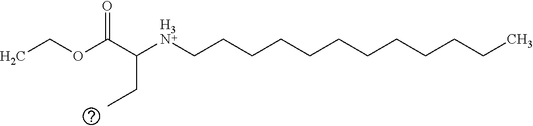 |
| 53 | 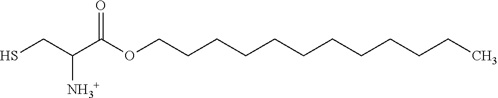 [SMILES: CCCCCCCCCCCCOC(=O)C([NH3+])CS] |
| 54 | 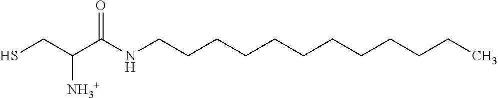 [SMILES: CCCCCCCCCCCCNC(=O)C([NH3+])CS] |
| 55 | 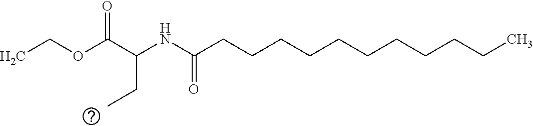 [SMILES: CCCCCCCCCCCC(=O)NC(CC)C(=O)OCC] |
| 56 | 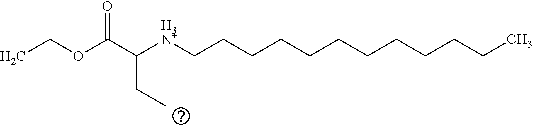 |
| 57 | 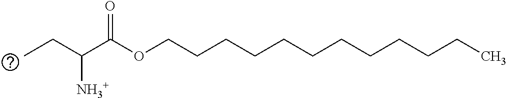 [SMILES: CCCCCCCCCCCCOC(=O)C([NH3+])CC] |
| 58 | 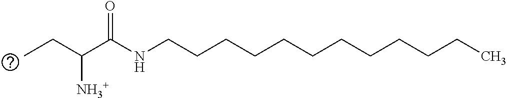 [SMILES: CCCCCCCCCCCCNC(=O)C([NH3+])CC] |
| 59 | 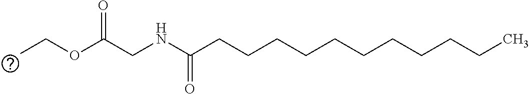 [SMILES: CCCCCCCCCCCC(=O)NCC(=O)OCC] |
| 60 | 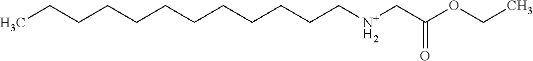 |
| 61 | 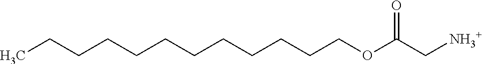 [SMILES: CCCCCCCCCCCCOC(=O)C[NH3+]] |
| 62 | 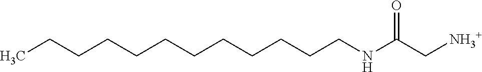 [SMILES: CCCCCCCCCCCCNC(=O)C[NH3+]] |
| 63 | 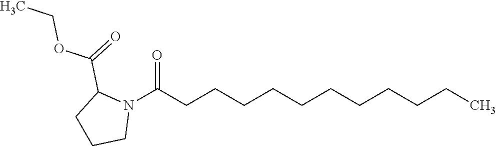 [SMILES: CCCCCCCCCCCC(=O)N1CCCC1C(=O)OCC] |
| 64 | 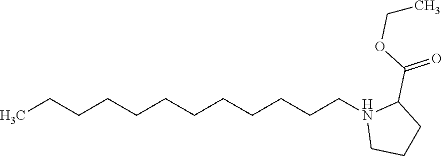 |
| 65 | 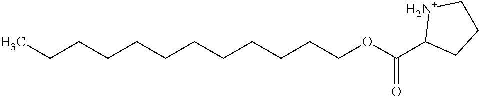 [SMILES: CCCCCCCCCCCCOC(=O)C1CCC[NH2+]1] |
| 66 | 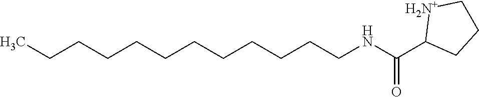 [SMILES: CCCCCCCCCCCCNC(=O)C1CCC[NH2+]1] |
| 67 | 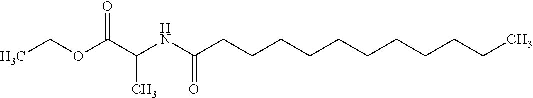 [SMILES: CCCCCCCCCCCC(=O)NC(C)C(=O)OCC] |
| 68 | 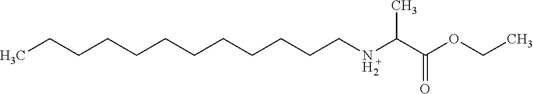 [SMILES: CCCCCCCCCCCCNC(C)C(=O)OCC] |
| 69 | 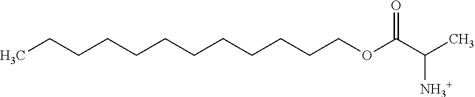 [SMILES: CCCCCCCCCCCCOC(=O)C(C)[NH3+]] |
| 70 | 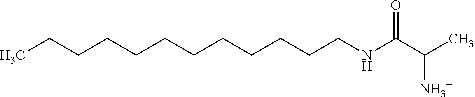 [SMILES: CCCCCCCCCCCCNC(=O)C(C)[NH3+]] |
| 71 | 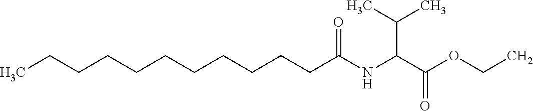 [SMILES: CCCCCCCCCCCC(=O)NC(C(=O)OCC)C(C)C] |
| 72 | 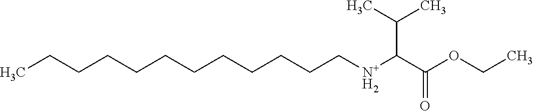 |
| 73 | 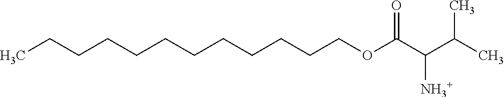 [SMILES: CCCCCCCCCCCCOC(=O)C([NH3+])C(C)C] |
| 74 | 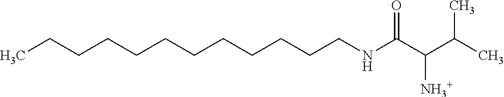 [SMILES: CCCCCCCCCCCCNC(=O)C([NH3+])C(C)C] |
| 75 | 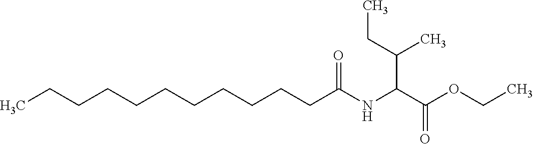 [SMILES: CCCCCCCCCCCC(=O)NC(C(=O)OCC)C(C)CC] |
| 76 | 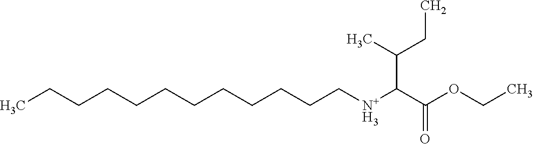 |
| 77 | 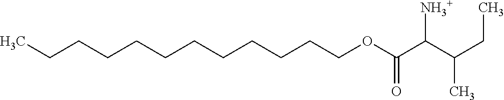 [SMILES: CCCCCCCCCCCCOC(=O)C([NH3+])C(C)CC] |
| 78 | 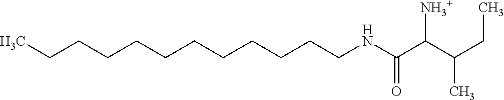 [SMILES: CCCCCCCCCCCCNC(=O)C([NH3+])C(C)CC] |
| 79 | 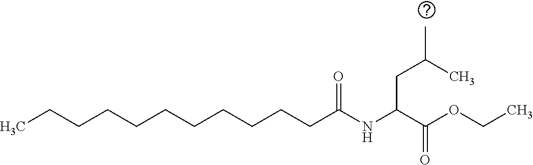 [SMILES: CCCCCCCCCCCC(=O)NC(CC(C)C)C(=O)OCC] |
| 80 | 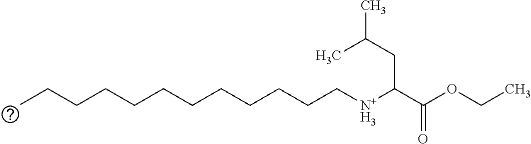 |
| 81 | 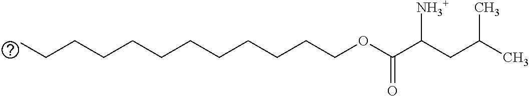 [SMILES: CCCCCCCCCCCCOC(=O)C([NH3+])CC(C)C] |
| 82 | 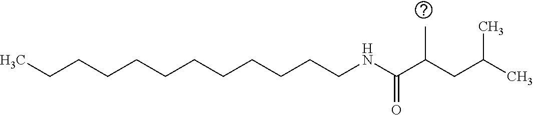 [SMILES: CCCCCCCCCCCCNC(=O)C(C)CC(C)C] |
| 83 | 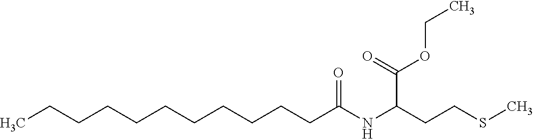 [SMILES: CCCCCCCCCCCC(=O)NC(CCSC)C(=O)OCC] |
| 84 | 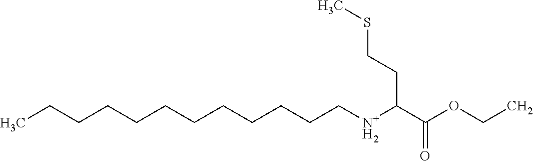 |
| 85 | 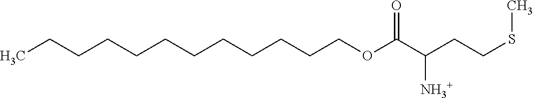 [SMILES: CCCCCCCCCCCCOC(=O)C([NH3+])CCSC] |
| 86 | 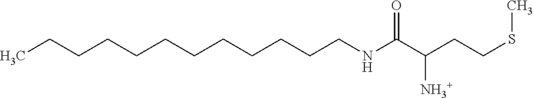 [SMILES: CCCCCCCCCCCCNC(=O)C([NH3+])CCSC] |
| 87 | 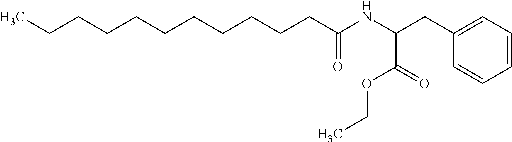 [SMILES: CCCCCCCCCCCC(=O)NC(Cc1ccccc1)C(=O)OCC] |
| 88 | 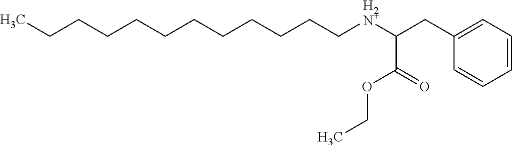 |
| 89 | 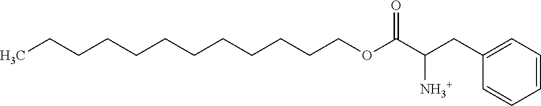 [SMILES: CCCCCCCCCCCCOC(=O)C([NH3+])Cc1ccccc1] |
| 90 | 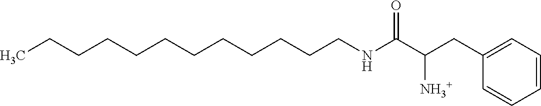 [SMILES: CCCCCCCCCCCCNC(=O)C([NH3+])Cc1ccccc1] |
| 91 | 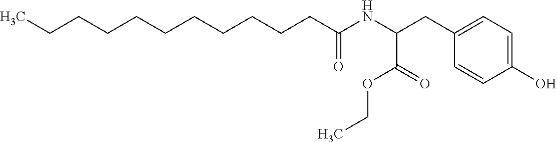 [SMILES: CCCCCCCCCCCC(=O)NC(Cc1ccc(O)cc1)C(=O)OCC] |
| 92 | 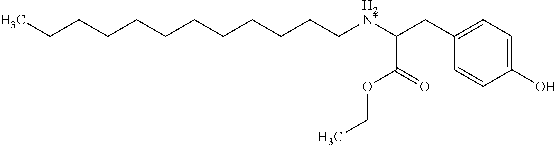 |
| 93 | 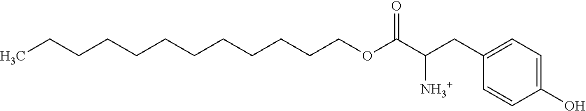 [SMILES: CCCCCCCCCCCCOC(=O)C([NH3+])Cc1ccc(O)cc1] |
| 94 | 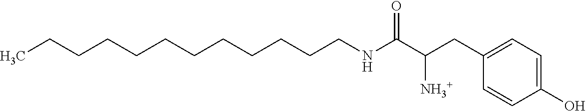 [SMILES: CCCCCCCCCCCCNC(=O)C([NH3+])Cc1ccc(O)cc1] |
| 95 | 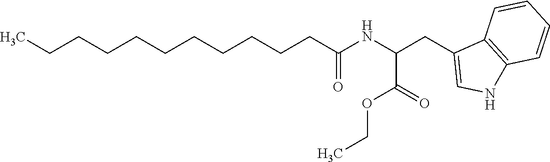 [SMILES: CCCCCCCCCCCC(=O)NC(Cc1c[nH]c2ccccc12)C(=O)OCC] |
| 96 | 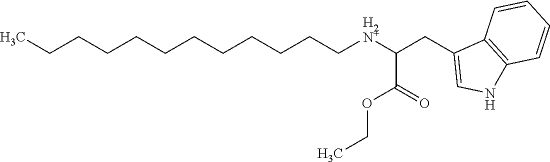 |
| 97 | 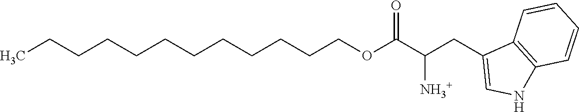 [SMILES: CCCCCCCCCCCCOC(=O)C([NH3+])Cc1c[nH]c2ccccc12] |
| 98 | 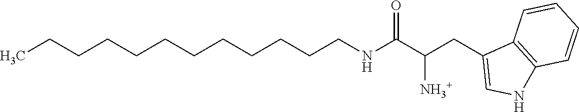 [SMILES: CCCCCCCCCCCCNC(=O)C([NH3+])Cc1c[nH]c2ccccc12] |

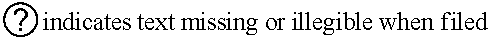

One or more alkylated amino acid surfactant compounds having antimicrobial properties as described herein can be provided in a cleaning composition as described herein in an amount from about 0.01 weight percent (wt %) to about 20 wt %, e.g., from about 0.01 wt % to about 15 wt %, or from about 0.01 wt % to about 5 wt %, or from about 0.01 wt % to about 1 wt %, or from about 0.1 wt % to about 1 wt % (e.g., about 0.3 wt %), of the cleaning composition.

### Surfactants

Surfactants (i.e., surfactant compounds provided in addition to alkylated amino acid surfactant compounds provided as antimicrobial agents) can be provided in the cleaning compositions to facilitate solubility of other components within as well as provide cleaning properties for the cleaning compositions. Non-ionic, anionic, cationic, and/or amphoteric/zwitterionic surfactants can be provided for a cleaning composition. Generally, surfactants that can be provided in the cleaning compositions include an ethoxylated alcohol, an alkyl polyglucoside, an amine oxide, a biosurfactant (e.g., one or more sophorolipids, one or more rhamnolipids, etc.), and any combination or mixture thereof. Surfactants can be provided in a cleaning composition as described herein in an amount from about 0.05 wt % to about 15 wt %, or from about 0.1 wt % to about 10 wt %, or from about 0.1 wt % to about 5 wt %, or from about 1 wt % to about 5 wt %, of the cleaning composition. Specific examples of surfactants that can be provided in the cleaning compositions are provided as follows.

### Non-Ionic Surfactants

Non-limiting examples of non-ionic surfactants suitable for providing in the cleaning compositions include alkoxylated alcohol surfactants having the general formula:

RO—(Z)ₙH, (Formula 4)

wherein:
R is straight or branched chain C₄ to C₁₈, or C₆ to C₁₆, or C₁₀ to C₁₆, or C₁₂ to C₁₄, or a C₆ to C₂₈ alkyl benzene chain;
Z is ethoxy or propoxy or butoxy, or any combinations or mixtures thereof; and
n is an integer from 1 to 30, or from 1 to 15, or from 3 to 12, or from 3 to 8.

Some further non-limiting examples of suitable branched alkoxylated alcohols are, e.g., Ecosurf® EH3, EH6, and EH9 (commercially available from Dow Chemical Company), and Lutensol® XP alkoxylated Guerbet alcohols & Lutensol® XL ethoxylated Guerbet alcohols (commercially available from BASF Corporation). Some non-limiting examples of suitable linear alkoxylated nonionic surfactants for use herein are Dobanol® 91-2.5 (R is a mixture of C₉ and C₁₁ alkyl chains, n is 2.5), Dobanol® 91-5 (R is a mixture of C₉ to C₁₁ alkyl chains, n is 5), Dobanol® 91-10 (R is a mixture of C₉ to C₁₁ alkyl chains, n is 10), Greenbentine DE60 (R is a C₁₀ linear alkyl chain, n is 6), Marlipal 10-8 (R is a C₁₀ linear alkyl chain, n is 8), Neodol 91-8 (R is a mixture of C₉ to C₁₁ alkyl chains, n is 8), Empilan® KBE21 (R is a mixture of C₁₂ and C₁₄ alkyl chains, n is 21), Lutensol ON30 (R is C₁₀ linear alkyl chain, n is 3), Lutensol ON50 (R is C₁₀ linear alkyl chain, n is 5), Lutensol ON70 (R is C₁₀ linear alkyl chain, n is 7), Novel 610-3.5 (R is mixture of C₆ to C₁₀ linear alkyl chains, n is 3.5), Novel 810FD-5 (R is mixture of C₈ to C₁₀ linear alkyl chains, n is 5), Novel 10-4 (R is C₁₀ linear alkyl chain, n is 4); Novel 1412-3 (R is mixture of C₁₂ to C₁₄ linear alkyl chains, n is 3), Lialethl® 11-5 (R is a C₁₁ linear alkyl chain, n is 5), Lialethl® 11-21 (R is a mixture of linear and branched C₁₁ alkyl chain, n is 21), or combinations or mixtures thereof.

Another example of an alkoxylated non-ionic surfactant is a secondary alcoholic ethoxylate such as surfactants under the tradename TERGITOL (commercially available from Dow Chemical Company).

Further examples of non-ionic surfactants include an alkyl ethoxy alkoxy alcohol, where the alkoxy portion can be propoxy, butoxy, or propoxy-butoxy, and the weight average molecular weight of the alkyl ethoxy alkoxy alcohol can be from 500 to 2000 g/mol, or from 600 to 1700 g/mol, or from 800 to 1500 g/mol. The ethoxylated alkoxylated non-ionic surfactant can be a polyoxyalkylene copolymer, such as a block-heteric ethoxylated alkoxylated nonionic surfactant and/or surfactants under the tradename PLURONIC (commercially available from BASF Corporation).

Some specific non-limiting examples of alkoxylated nonionic surfactants that can be particularly suitable for use in cleaning compositions including antimicrobial alkylated amino acid compounds as described herein include 2-propylheptyl EO8 (Lutensol XL89-BASF), 2-propylheptyl EO5 (Lutensol XL50-BASF), C₁₀ alcohol EO5 (Lutensol ON 50-BASF), C₁₀-alcohol EO7 (Lutensol ON 70-BASF), C₈-C₁₀ EO5 (Novel 810 FD5 Sasol), C₁₀ EO4 (Novel 10-4 Sasol), Tergitol 15-S-3, Tergitol 15-S-5, Tergitol 15-S-7, and Ethyl hexanol P05EO6 (Ecosurf EH6-Dow).

Further non-ionic surfactants suitable for use in the cleaning compositions can include alkyl polyglucosides having the general formula:

CₙH₂ₙ₊₁O(C₆H₁₀O₅)ₓH (Formula 5)

wherein:
n is from 8 to 16, or from 8 to 14; and
x is at least 1.

Non-limiting examples of suitable alkyl polyglucoside surfactants include those under the tradename TRITON (commercially available from Dow Company), Agnique PG, Disponil APG and Glucopon alkyl polyglucosides (commercially available from BASF Corporation).

Further examples of non-ionic surfactants include alkyl amine oxides including straight or branched, substituted or unsubstituted, saturated or unsaturated carbon chains of 1 to 30 carbon atoms (e.g., lauryl amine oxide), and alkyl glucamide surfactants (e.g., N-alkyl-N-acylglucamides) in which the hydrophilic and hydrophobic moieties are linked via amide bonds such as N-octanoyl-N-methylglucamide, N-nonanoyl-N-methylglucamide, N-decanoyl-N-methylglucamide, N-dodecanoyl-N-methylglucamide, N-cocoyl-N-methylglucamide, N-lauroyl/myristoyl-N-methylglucamide, and N-octanoyl/decanoyl-N-methylglucamide.

### Cationic Surfactants

Non-limiting examples of cationic surfactants suitable for providing in the cleaning compositions include quaternary ammonium surfactants, which can have up to 26 carbon atoms and may include alkoxylate quaternary ammonium (AQA) surfactants, dimethyl hydroxyethyl quaternary ammonium, and/or dimethyl hydroxyethyl lauryl ammonium chloride, polyamine cationic surfactants, cationic ester surfactants, amino surfactants, e.g., amido propyldimethyl amine (APA), and any suitable combinations or mixtures thereof.

Specific non-limiting examples of suitable cationic surfactants include alkyl pyridinium compounds, alkyl quaternary ammonium compounds, alkyl quaternary phosphonium compounds, alkyl ternary sulphonium compounds, and suitable combinations or mixtures thereof. In addition, suitable cationic surfactants that can be provided in the cleaning solutions are quaternary ammonium compounds that can include linear or branched, substituted or unsubstituted C₆₋₁₈ alkyl or alkenyl moieties and/or hydroxyl, hydroxymethyl or hydroxyethyl moieties, and further including an anion which provides charge neutrality, where the anion can be a halide (e.g. chloride), a sulphate, or a sulphonate. Some specific examples of suitable quaternary ammonium surfactant compounds include mono-C₆₋₁₈ alkyl mono-hydroxyethyl di-methyl quaternary ammonium chlorides, such as di-C₈₋₁₀ alkyl di-methyl quaternary ammonium chloride, mono-C₁₆ alkyl tri-methyl quaternary ammonium chloride, di-C₁₀₋₁₂ alkyl di-methyl quaternary ammonium chloride, and mono-Cio alkyl mono-hydroxyethyl di-methyl quaternary ammonium chloride.

### Anionic Surfactants

It is preferable that the cleaning compositions described herein are either free of anionic surfactant or only contain a minimal amount of anionic surfactant (e.g., no greater than about 0.1% by weight of the cleaning composition). Some non-limiting examples of anionic surfactants that can be provided in the formulations include sulfates such as alkyl sulfates (e.g., C₈-C₁₈ linear or branched alkyl sulfates such as sodium lauryl sulfate (SLS), and sodium tetradecylsulfate), sulfonates such as alkyl sulfonates (e.g., C₆-C₁₈ linear or branched alkyl sulfonates such as sodium octane sulfonate and sodium secondary alkane sulfonate, alkyl ethoxysulfates, fatty acids and fatty acid salts (e.g., C₆-C₁₆ fatty acid soaps such as sodium laurate), and alkyl amino acid derivatives. Other examples may include sulfate derivatives of alkyl ethoxylate propoxylates, alkyl ethoxylate sulfates, alpha olefin sulfonates, C₆-C₁₆ acyl isethionates (e.g. sodium cocoyl isethionate), C₆-C₁₈ alkyl, aryl, or alkylaryl ether sulfates, C₆-C₁₈ alkyl, aryl, or alkylaryl ether methylsulfonates, C₆-C₁₈ alkyl, aryl, or alkylaryl ether carboxylates, sulfonated alkyldiphenyloxides (e.g. sodium dodecyldiphenyloxide disulfonate), and the like. A non-limiting example embodiment of a specific anionic surfactant that can be provided in the formulations as described herein is an Alkyldiphenyloxide Disulfonate commercially available under the tradename DOWFAX 2A1 (Dow Inc., Michigan).

### Zwitterionic and Amphoteric Surfactants

The cleaning compositions may further include an amphoteric surfactant, a zwitterionic surfactant, and combinations or mixtures thereof.

Suitable zwitterionic surfactants typically contain both cationic and anionic groups in substantially equivalent proportions so as to be electrically neutral at the pH of use, and are well known in the art. Some examples of well known zwitterionic surfactants are described in U.S. Pat. Nos. 2,702,279 and 2,255,082, each of which is incorporated herein by reference in its entirety. Specific examples of suitable zwitterionic surfactants include betaines, such alkyl betaines, alkylamidobetaine, amidazoliniumbetaine, sulfobetaine (INCI Sultaines) as well as the phosphobetaine.

Suitable amphoteric surfactants include those under the tradename MIRANOL (commercially available from Solvay-Novecare), such as sodium lauroamphoacetate (Miranol Ultra L-32E), sodium stearoampho acetate (Miranol DM), disodium cocoamphodiacetate (Miranol C2m Conc NP), disodium lauroamphodiacetate (Miranol BM Conc), disodium capryloampho dipropionate (Miranol JBS), sodium mixed C₈ amphocarboxylate (Miranol JEM Conc), and sodium capryloampho hydroxypropyl sulfonate (Miranol JS). Other non-limiting examples of suitable amphoteric surfactants are disodium capryloamphodiacetate (Mackam 2CY 75-Solvay Novecare), octyliminodipropionate (Ampholak YJH40-Akzo Nobel), sodium lauriminodipropionate (Mirataine H2C-HA-Solvay Novecare), and sodium lauroamphohydroxypropylsulfonate (Mackam LS-Solvay Novecare).

Still other examples of amphoteric and/or zwitterionic surfactants include alkyl amine oxides such as C₈ dimethyl amine oxide, C₁₀ dimethyl amine oxide, C₁₂ dimethyl amine oxide, C₁₄ dimethyl amine oxide, and combinations or mixtures thereof. Specific examples include C₈, C₁₀ and C₁₂ dimethyl amine oxides and cocoyldiethoxy amine oxides under the tradename GENAMINOX (commercially available from Clariant), and C₁₄ dimethyl amine oxides and cocamydopropyl amine oxides under the trade name trade name EMPIGEN (commercially available from Huntsman) and AMMONYX (commercially available from Stepan).

### Solvents

Any suitable one or more solvents can optionally be provided in the cleaning compositions. Non-aqueous solvents can be provided including, without limitation, a solvent comprising carbon, oxygen and hydrogen. For example, suitable non-aqueous solvents include glycol ethers, alkyl esters, alcohols, diols, and combinations or mixtures thereof.

In certain embodiments, the solvent can comprise a short chain (e.g., C1-C3) alcohol, such as methanol, ethanol and propanol. In other embodiments, the solvent can comprise a longer chain (e.g., C4-C10) diol, such as 1,2-hexane diol, 1,2-octanediol and 1,4 butanediol.

The solvent can comprise a glycol ether. The glycol ether can include one or more linear and/or branched chain C₂-C₈ alkyl groups. Some non-limiting examples of glycol ethers used as solvents for the cleaning compositions include ethyleneglycol n-butyl ether, diethyleneglycol n-butyl ether, triethyleneglycol n-butyl ether, propyleneglycol n-butyl ether, dipropyleneglycol n-butyl ether, tripropyleneglycol n-butyl ether, and combinations or mixtures thereof.

The one or more solvents can be provided in the clean compositions in an amount ranging from about 0.05 wt % to about 15 wt %, or from about 0.10 wt % to about 10 wt %.

### Additional Excipients/Ingredients

Any one or more excipients or additional ingredients can optionally be provided in the cleaning compositions including, without limitation, chelators, salts, builders, fragrances, colorants, dyes, preservatives, thickeners, and pH adjusters.

Some non-limiting examples of suitable chelators include ethylene diamine tetra methylene phosphonates, diethylene triamine penta methylene phosphonates (DTPMP), ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanoldiglycines, and methyl glycine diacetic acid (MGDA).

Suitable pH adjusting agents that can be provided in the cleaning compositions include, without limitation, organic acids (e.g., citric acid), mineral acids, alkali metal and alkaline earth salts of citrate, silicate (e.g., sodium silicate, sodium metasilicate, sodium orthosilicate, potassium silicate, potassium metasilicate, potassium orthosilicate, etc.), metasilicate, polysilicate, borate (e.g., sodium borate, potassium borate, etc.), carbonate (e.g. sodium carbonate, sodium bicarbonate, potassium carbonate, potassium bicarbonate, etc.), carbamate, phosphate (e.g., sodium phosphate, sodium polyphosphate, potassium phosphate, potassium polyphosphate, etc.), polyphosphate, pyrophosphates, triphosphates, tetraphosphates, ammonia, hydroxide (e.g., sodium hydroxide, potassium hydroxide, etc.), monoethanolamine, monopropanolamine, diethanolamine, dipropanolamine, triethanolamine, and/or 2-amino-2-methylpropanol, and any combinations thereof.

Non-limiting examples of suitable fragrances include essential oils (e.g., from botanical or other naturally derived sources, such as butyl levulinate), synthetic fragrance oils and/or any other suitable type of fragrance composition that meets the EPA's Safer Choice criteria or requirements.

Water is also provided in the cleaning compositions and can be present in an amount of at least about 50 wt % of the cleaning composition. For example, water can be provided in an amount from about 50 wt % to about 98 wt %, e.g., about 99 wt %, or greater of the cleaning composition. In some embodiments, cleaning compositions include the antimicrobial agent (which includes one or more alkylated amino acids), one or more surfactants, optionally one or more solvents, chelators, salts, builders, fragrances, dyes, preservatives, thickeners, pH adjusters, and any combinations or mixtures thereof, and water forming the balance or remainder of the cleaning compositions. In some example embodiments, a cleaning composition can consist essentially of antimicrobial agent (including one or more alkylated amino acids) and water.

As previously noted herein, the cleaning compositions can include one or more alkylated amino acid surfactant compounds that have a net positive molecular charge, e.g., even at a pH of 7 or greater. In particular, at least one alkylated amino acid of the antimicrobial agent can have a net positive molecular charge. The cleaning compositions further can be formulated to have a pH ranging from 3 to 12, or a pH ranging from 5 to 11.

Further, each component or ingredient of the cleaning composition, including each antimicrobial alkylated amino acid compound, as well as the amounts of each ingredient in the cleaning composition, can be selected so as to meet the EPA Safer Choice Standard, while still being effective in cleaning hard and soft surfaces. In one embodiment of the invention, the cleaning composition will meet DfE requirements, the EPA's Category III or IV requirements, and/or while also being safe for food contact surfaces without rinsing with water, e.g., under 40 CFR 180.940(a). In some embodiments of the invention, all of the components or substantially all components of the inventive compositions meet the EPA guidelines under 40 CFR 180.940(a) or 40 CFR 180.950 or 40 CFR 180.960 which all reflect a presumption of low toxicity. Under the EPA's Category III or IV, no personal protective equipment is required for using the composition. The ability for a cleaning composition to simultaneously meet such safety and environmentally friendly requirements, while providing sanitization and/or disinfection within a 10 minute, 7 minute or 5 minute contact time is surprising, and particularly advantageous.

The term “Safer Choice” means the U.S. EPA program that is focused on identifying safer sanitizing and disinfecting active ingredients. The pesticide portion of the “Safer Choice” program is called “Design for the Environment” or “DfE”. The EPA has a special approval process for products that meet the DfE criteria. The EPA, as part of the DfE program has identified certain active ingredients that are approved for antimicrobial cleaning products and authorized to use the DfE logo. The EPA Safer Choice Standard, as used herein, refers to the current guidelines as set forth in the most recent revision dated February 2015 and available at https://epa.gov/saferchoice/safer-choice-standard. The antimicrobial cleaning products that have been approved under the DE program may be found at this website. In addition, an exhaustive list of ingredients for cleaning compositions that meet the Safer Choice Standard are set forth in the document EPA's Safer Choice Program Master Criteria for Safer Ingredients, Version 2.1, September 2012, Safer Choice Master Criteria for Safer Chemical Ingredients|US EPA, the disclosure of which is incorporated herein by, reference in its entirety. All products approved for the DfE program must have only ingredients that meet the Safer Choice Standard.

Preferably, cleaning compositions that are most compliant under the Safer Choice Standard are those which exclude any 0-amide alkylated amino acid in the cleaning compositions (where examples of such O-amide alkylated amino acids are set forth in Tables 1 and 2 herein).

### Use of Cleaning Compositions

The cleaning compositions can be provided as liquid formulations for use in a spray bottle or any other suitable delivery device. The cleaning compositions can also be provided in concentrated form (i.e., as concentrates) which are diluted with water prior to use. For example, cleaning composition concentrates that include one or more alkylated amino acids can be provided such that they are diluted prior to use at a dilution ratio (concentrate to water) from about 1:10 to about 1:20. Cleaning composition concentrates can also be formulated herein so as to be solid, liquid or gel. The cleaning compositions can also be provided in other delivery devices, such as a substrate (e.g., cleaning composition impregnated in the wipes), where the weight ratio of wipe to cleaning composition can range from about 1:1 to about 1:10.

The cleaning compositions can be used for cleaning, sanitizing and/or disinfecting hard surfaces and soft surfaces. Hard surfaces are less porous than soft surfaces and include, e.g., floors, walls, table or counter tops, tiles, cupboards, sinks, showers, toilets, and any other surfaces comprising a hard material such as wood, ceramic, glass, vinyl, linoleum, steel (e.g., stainless steel) and other metals, etc. Soft surfaces can include, e.g., upholstered chairs, couches, cushions and other similar surfaces, carpet, curtains and any fabric or textile materials. Cleaning of hard and soft surfaces utilizing the cleaning compositions can be in any environment, including residential (e.g., household), commercial (e.g., office), medical (e.g., hospital or clinic) and/or industrial environments, as well as any outdoor environments (e.g., in garage, outside walls, inside automobiles, etc.).

### Antimicrobial Efficacy of Cleaning Compositions

Three different cleaning compositions were tested, where each composition included the following components and had a pH of about 7:
Cleaning composition 1: 0.3 wt % alkylated amino acid, 1 wt % surfactant (lauryl amine oxide), 0.5 wt % fragrance (butyl levulinate), and balance water (about 98.2 wt % water)
Cleaning Composition 2: 0.3 wt % alkylated amino acid, and balance water (about 99.7 wt % water)
Cleaning Composition 3: 0.3 wt % alkylated amino acid, 1 wt % surfactant (alkyl polyglucoside), and balance water (about 98.7 wt % water)

A number of tests were conducted for Cleaning Compositions 1-3 including different alkylated amino acids as set forth in Tables 1 and 2 as described herein. Tests were conducted using GST (germicidal spray test) testing method AOAC 961.02 for micro-efficacy (i.e., ability to kill bacteria) against Staphylococcus aureus. The contact time in the test method was 7 minutes, and the neutralizer utilized was Letheen Broth+0.07% Lecithin+0.5% Tween 80. Example test results are provided in Table 3 as follows:

TABLE 3
antimicrobial efficacy of cleaning compositions
for Staphylococcus aureus

| | GST efficacy in | GST efficacy in | GST efficacy in |
|---|---|---|---|
| Alkylated | Cleaning | Cleaning | Cleaning |
| Amino Acid | Composition 1 | Composition 2 | Composition 3 |
| Example 1 | >99.999% | >99.999% | |
| (Arginine) | | | |
| Example 2 | >99.999% | >99.999% | |
| (Arginine) | | | |
| Example 4 | >99.999% | >99.999% | |
| (Arginine) | | | |
| Example 5 | >99.999% | >99.999% | |
| (Arginine) | | | |
| Example 61 | >99.999% | | >99.8% |
| (Glycine) | | | |
| Example 60 | >99.999% | | |
| (Glycine) | | | |
| Example 62 | >99.999% | | >99.999% |
| (Glycine) | | | |
| Example 81 | >99.999% | 95.3% | >99.8% |
| (Leucine) | | | |
| Example 80 | 99.99% | 99.4% | |
| (Leucine) | | | |
| Example 82 | >99.999% | | >99.999% |
| (Leucine) | | | |
| Example 21 | >99.999% | >99.999% | |
| (Lysine) | | | |
| Example 16 | >99.999% | >99.999% | |
| (Lysine) | | | |
| Example 22 | >99.999% | >99.999% | |
| (Lysine) | | | |
| Example 17 | >99.999% | >99.999% | |
| (Lysine) | | | |
| Example 20 | >99.999% | >99.999% | |
| (Lysine) | | | |
| Example 89 | 99.999% | 99.5% | 99.6% |
| (Phenylalanine) | | | |
| Example 88 | 99.999% | | |
| (Phenylalanine) | | | |
| Example 90 | >99.999% | | >99.999% |
| (Phenylalanine) | | | |
| Example 97 | >99.999% | | |
| (Tryptophan) | | | |
| Example 96 | 99.999% | | |
| (Tryptophan) | | | |
| Example 98 | >99.999% | | 99.4% |
| (Tryptophan) | | | |
| Example 93 | >99.999% | 99.9% | 99.4% |
| (Tyrosine) | | | |
| Example 92 | 99.99% | | |
| (Tyrosine) | | | |
| Example 94 | >99.999% | | >99.999% |
| (Tyrosine) | | | |

The tests demonstrate that the cleaning compositions with alkylated amino acids as described herein provide at least a 3-log reduction, or even a 4-log reduction, or in some instances even a 5-log reduction, in Staphylococcus aureus population within a period of 10 minutes or less (e.g., within 7 minutes) when applied to a surface to be cleaned. While only a number of Examples from Tables 1 and 2 were tested, it is noted that this list was not exhaustive and other Examples from Tables 1 and 2 not provided in the list in Table 3 can perform in the same or similar manner with regard to antimicrobial efficacy.

### Stability of Cleaning Compositions

Cleaning compositions including one or more alkylated amino acids as described herein have also been found to be suitably stable over extended periods of time and at different temperature environments. To demonstrate stability, cleaning compositions were prepared including sampled alkylated amino acids as set forth in Tables 1 and 2 herein. The cleaning compositions were prepared using the formulation previously described herein as cleaning composition 1, where each tested cleaning composition was comprised of the following: 0.3 wt % alkylated amino acid, 1 wt % surfactant (lauryl amine oxide), 0.5 wt % fragrance (butyl levulinate), and balance water (about 98.2 wt % water).

The stability tests were tested for amino acid stability at different temperatures, 70° F. (21° C.) and 100° F. (38° C.), over the following periods of time: 4 weeks (4w) and 8 weeks (8w). The samples tested were subjected to HPLC-UV analysis, and the peak areas of the plotted data corresponding to the alkylated amino acids in the samples at 4w and 8w were compared with the reference (sample at t=0) to obtain a percentage value (based upon measured area at different times divided by measured area of reference, t=0). Example stability test results are provided in Table 4:

TABLE 4

| | | % at | % at | % at | % at |
|---|---|---|---|---|---|
| Alkylated | | t = 4 w | t = 8 w | t = 4 w | t = 8 w |
| Amino Acid | Alkylation | (70° F.) | (70° F.) | (70° F.) | (100° F.) |
| Example 1 | N-acyl, | 80 | 71 | 50 | 27 |
| (Arginine) | O-ester | | | | |
| Example 2 | N-alkyl | 100 | 100 | 100 | 100 |
| (Arginine) | | | | | |
| Example 4 | O-amide | 106 | 112 | 97 | 81 |
| (Arginine) | | | | | |
| Example 61 | O-ester | 0 | 0 | 0 | 0 |
| (Glycine) | | | | | |
| Example 60 | N-alkyl, | 8 | 0 | 0 | 0 |
| (Glycine) | O-ester | | | | |
| Example 62 | O-amide | 90 | 87 | 75 | 59 |
| (Glycine) | | | | | |
| Example 81 | O-ester | 64 | 36 | 14 | 5 |
| (Leucine) | | | | | |
| Example 80 | N-alkyl, | 93 | 85 | 103 | 89 |
| (Leucine) | O-ester | | | | |
| Example 82 | O-amide | 90 | 100 | 98 | 93 |
| (Leucine) | | | | | |
| Example 21 | N-acyl, | 13 | 4 | 0 | 0 |
| (Lysine) | O-ester | | | | |
| Example 16 | N-acyl, | 88 | 79 | 58 | 37 |
| (Lysine) | O-ester | | | | |
| Example 22 | N-alkyl | 100 | 150 | 120 | 146 |
| (Lysine) | | | | | |
| Example 17 | N-alkyl | 90 | 102 | 87 | 102 |
| (Lysine) | | | | | |
| Example 20 | O-amide | 97 | 89 | 76 | 62 |
| (Lysine) | | | | | |
| Example 89 | O-ester | 82 | 63 | 41 | 12 |
| (Phenylalanine) | | | | | |
| Example 88 | N-alkyl, | 93 | 91 | 96 | 74 |
| (Phenylalanine) | O-ester | | | | |
| Example 90 | O-amide | 104 | 101 | 101 | 96 |
| (Phenylalanine) | | | | | |
| Example 97 | O-ester | 92 | 73 | 39 | 6 |
| (Tryptophan) | | | | | |
| Example 96 | N-alkyl, | 94 | 87 | 72 | 35 |
| (Tryptophan) | O-ester | | | | |
| Example 98 | O-amide | 118 | 135 | 133 | 121 |
| (Tryptophan) | | | | | |
| Example 93 | O-ester | 75 | 56 | 30 | 8 |
| (Tyrosine) | | | | | |
| Example 92 | N-alkyl, | 99 | 59 | 83 | 57 |
| (Tyrosine) | O-ester | | | | |
| Example 94 | O-amide | 98 | 94 | 93 | 86 |
| (Tyrosine) | | | | | |

Percentage values of 70% or greater indicate adequate stability of the alkylated amino acids within the cleaning compositions over the 4 and 8 week time periods and at the given temperatures, where increasing percentage values (e.g., above 85%, 90% or even at or greater than 100%) indicate very stable cleaning compositions with little or no degradation of the alkylated amino acids within the compositions. This indicates that the cleaning compositions with alkylated amino acids as described herein provide suitable shelf life stability in typical ambient (e.g., room temperature) environments (e.g., when stored in typical household, business or industrial settings).

Thus, the cleaning compositions described herein provide an antimicrobial agent in the form of an alkylated amino acid surfactant compound that can be used to safely and effectively clean hard and soft surfaces and to further sanitize and/or disinfect such surfaces by reducing and/or inhibiting microbial growth along such surfaces. The cleaning compositions are further suitably stable for storage and use over extended periods of time. The cleaning compositions also can be suitably formulated to meet EPA Safer Choice and DfE standards.

While the invention has been described in detail and with reference to specific embodiments thereof, it will be apparent to one skilled in the art that various changes and modifications can be made therein without departing from the spirit and scope thereof.

What is claimed:

1. A cleaning composition comprising:
(a) an antimicrobial agent comprising one or more proteinogenic amino acids modified via alkylation, each proteinogenic amino acid modified via alkylation having a chemical structure with the following formula:
R₁—CH(NR_{2A}R_{2B})—C(═O)-M (Formula 1)
wherein:
M is —OR_{3A} or —NR_{3B}R_{3C};
R₁ is an unsubstituted side chain at the α-carbon of the proteinogenic amino acid, or a substituted side chain at the α-carbon of the proteinogenic amino acid, wherein the substituted side chain is selected from the group consisting of:
—(C₃H₆)—NH—C(═NH)—NH—R₄,
—(C₄H₈)—NH—R₄,
—CH₂—C(═O)—O—R₄, and
—(C₂H₄)—C(═O)—O—R₄;
each of R_{2A} and R_{2B} is separately and independently selected from the group consisting of hydrogen, a C₈-C₁₆ alkyl group, a C₃ alkyl group forming a cyclic ring with the α-carbon and nitrogen atom bonded with the α-carbon, and a C₈-C₁₆ carbonyl group;
each of R_{3A}, R_{3B} and R_{3C} is separately and independently hydrogen or a C₂-C₁₆ alkyl group;
R₄ is a C₂-C₁₆ alkyl group or a C₈-C₁₆ carbonyl group; and
at least one of the one or more proteinogenic amino acids modified via alkylation has a positive molecular charge;
(b) a surfactant comprising a nonionic surfactant or a zwitterionic surfactant; and
(c) optionally, one or more solvents, chelators, salts, builders, fragrances, dyes, preservatives, thickeners, pH adjusters, and any combinations or mixtures thereof;
wherein the cleaning composition has a pH from 3 to 12.

2. The cleaning composition of claim 1, wherein the alkylated amino acid comprises a chemical structure with the formula:
R₁—CH(NR_{2A}R_{2B})—C(O)—O—R_{3A} (Formula 2).

3. The cleaning composition of claim 1, wherein the alkylated amino acid comprises a chemical structure with the formula:
R₁—CH(NR_{2A}R_{2B})—C(═O)—NR_{3B}R_{3C} (Formula 3).

4. The cleaning composition of claim 1, wherein R₁ is —(C₃H₆)—NH—C(═NH)—NH—R₄ or —(C₄H₈)—NH—R₄.

5. The cleaning composition of claim 1, wherein R_{2A} is hydrogen and R_{2B} is a C₈-C₁₆ alkyl group or a C₈-C₁₆ carbonyl group.

6. The cleaning composition of claim 1, wherein each of R_{2A} is hydrogen and R_{2B} is separately and independently a C₈-C₁₆ alkyl group or a C₈-C₁₆ carbonyl group.

7. The cleaning composition of claim 2, wherein R_{3A} is a C₂-C₁₆ alkyl group.

8. The cleaning composition of claim 3, wherein one or both of R_{3B} and R_{3C} is a C₂-C₁₆ alkyl group.

9. The cleaning composition of claim 1, wherein one or more of R₁, R_{2A}, R_{2B}, R_{3A}, R_{3B} and R_{3C} has a positive charge.

10. The cleaning composition of claim 1, wherein the composition further comprises a solvent, the solvent comprising an alkyl ester.

11. The cleaning composition of claim 1, wherein the surfactant is selected from the group consisting of an ethoxylated alcohol, an alkyl polyglucoside, an amine oxide, a biosurfactant, and any combination or mixture thereof.

12. The cleaning composition of claim 1, wherein the composition further comprises a solvent selected from the group consisting of a glycol ether, a short chain C₁-C₃ alcohol, an alkyl ester, and any combination or mixture thereof.

13. The cleaning composition of claim 1, wherein the composition provides at least 3-log reduction in Staphylococcus aureus within a period of 10 minutes or less.

14. The cleaning composition of claim 1, wherein the cleaning composition has a pH from 5 to 11.

15. The cleaning composition of claim 1, wherein the cleaning composition excludes any O-amide alkylated amino acid.

16. The cleaning composition of claim 1, wherein the cleaning composition includes the following:
the alkylated amino acid in an amount from about 0.01% to about 15% by weight of the cleaning solution;
the surfactant in an amount from about 0.10% to about 10% by weight of the cleaning solution; and
water.

17. A cleaning composition comprising:
(a) an antimicrobial agent comprising one or more alkylated amino acids selected from the group consisting of a N-acyl amino acid, an O-ester amino acid, a N-alkyl amino acid, an 0-amide amino acid, and any combination thereof;
(b) a surfactant in an amount from about 0.1% to about 10% by weight of the cleaning composition, wherein the surfactant comprises a nonionic surfactant or a zwitterionic surfactant;
(c) optionally one or more solvents, chelators, salts, builders, fragrances, dyes, preservatives, thickeners, pH adjusters, and any combinations or mixtures thereof; and
(d) water;
wherein:
the alkylated amino acid has a positive molecular charge; and
the cleaning composition has a pH from 3 to 12.

18. The cleaning composition of claim 17, wherein the cleaning composition has a pH from 5 to 11.

19. The cleaning composition of claim 17, wherein the cleaning composition provides at least 3-log reduction in Staphylococcus aureus within a period of 10 minutes or less.

20. A cleaning composition comprising:
(a) an antimicrobial agent comprising one or more alkylated amino acids provided in an amount from about 0.01% to about 15% by weight of the cleaning composition, wherein at least one of the one or more alkylated amino acids has a positive molecular charge;
(b) a surfactant in an amount from about 0.10% to about 10% by weight of the cleaning composition, wherein the surfactant comprises a nonionic surfactant or a zwitterionic surfactant;
(c) optionally one or more solvents, chelators, salts, builders, fragrances, dyes, preservatives, thickeners, pH adjusters, and any combinations or mixtures thereof; and
(d) water.

21. The cleaning composition of claim 20, wherein:
the cleaning composition has a pH from 3 to 12; and
the cleaning composition provides at least 3-log reduction in Staphylococcus aureus within a period of 10 minutes or less.
